(19) United States
(12) Patent Application Publication
(10) Pub. No.: US 2026/0179829 A1
(43) Pub. Date: Jun. 25, 2026

(54) INTEGRATED INDUCTORS FOR MULTIPHASE POWER SUPPLIES

(71) Applicant: NVIDIA CORPORATION, Santa Clara, CA (US)

(72) Inventors: Ziyuan ZHENG, Shenzhen, Guangdong (CN); Sien CHEN, Shenzhen, Guangdong (CN); Venkat KURUTURI, San Jose, CA (US); Siqi LI, Shenzhen, Guangdong (CN); Xiang SUN, Los Gatos, CA (US); Lizhi ZENG, Shenzhen, Guangdong (CN); Qianlong ZHU, Shenzhen, Guangdong (CN)

(21) Appl. No.: 18/727,314

(22) PCT Filed: Feb. 9, 2024
(86) PCT No.: PCT/CN2024/077124

§ 371 Date: Jul. 8, 2024

Related U.S. Application Data
(63) Continuation-in-part of application No. 18/699,181.

(30) Foreign Application Priority Data
Oct. 25, 2023 (WO) PCT/CN2023/126556

(51) Int. Cl. H01F 27/29; H01F 27/24; H02M 7/00

(52) U.S. Cl. CPC H01F 27/292; H01F 27/24; H02M 7/003

(57) ABSTRACT

Disclosed is an integrated inductor package comprising a magnetic core, a first conductive coil coupled to the magnetic core and a second conductive coil coupled to the magnetic core. The first conductive coil is disposed on a first side of the integrated inductor package and coupled between a first input pin and a first output pin. The second conductive coil is disposed on a second side of the integrated inductor package and coupled between a second input pin and a second output pin.

### CROSS-REFERENCE TO RELATED APPLICATIONS

This application claims priority to International Application Number PCT/CN 2023/126556, having a filing date of Oct. 25, 2023, titled “INTEGRATED INDUCTORS FOR MULTIPHASE POWER SUPPLIES.” The subject matter of this related application is hereby incorporated herein by reference.

### BACKGROUND

### Field of the Various Embodiments

Embodiments of the present disclosure relate generally to electrical engineering and electronics and, more specifically, to integrated inductor packages for multiphase power supplies.

### Description of the Related Art

Various high-performance computing systems and devices, including datacenter server machines, storage systems, graphics processors, and personal computers, incorporate different electronic components, such as processors, memory, high-current application-specific integrated circuits (ASICs) and/or field programmable gate arrays (FPGAs) that demand large amounts of power during operation. Traditionally, single-phase power supplies, such as single-phase buck converters, boost converters, and flyback converters, have been implemented in high-performance computing systems and devices to power these types of electronic components. However, conventional single-phase power supply designs have struggled to keep pace with the increasing power demands (e.g., 100 watts, 200 watts, or more) of electronic components included in high-performance computing systems and devices.

In an effort to address the shortcomings of conventional single-phase power supplies, multiphase power supplies have become more prevalent in high-performance computing systems and devices. When compared to single-phase power supplies, multiphase power supplies can deliver large amounts of power (e.g., 300 watts, 400 watts, or more) to the different electronic components in a computing system or device far more efficiently. In one type of conventional multiphase power supply design, each phase of a multiphase power supply includes a respective phase switch, such as a MOSFET, that is coupled to a load (e.g., an electronic component) using an inductor. The different inductors operate to improve the overall transient response of the multiphase power supply and also to reduce electromagnetic interference (EMI).

One drawback of the above conventional multiphase power supply design, however, is that the different inductors occupy large amounts of physical space and are difficult to fit on a printed circuit board. Accordingly, because each phase in a multiphase power supply includes a respective inductor, multiphase power supplies that include a relatively large number of power phases (e.g., 10, 16, 24, etc.) require an impractical amount of space to accommodate all of the inductors. Consequently, fitting multiphase power supplies that include a relatively large number of power phases into newer and smaller high-performance computing systems and devices is becoming increasingly difficult. Furthermore, because inductors occupy large amounts of physical space, many of the phase switches included in a conventional multiphase power supply have to be arranged on a printed circuit board relatively far away from the load to which the phase switches are supplying power. Consequently, the lengths of the conductors along which current flows from the phase switches to the loads have to be increased, which increases the copper losses and the overall response times of the multiphase power supply.

As the foregoing illustrates, what is needed are more effectively multiphase power supply designs.

### SUMMARY

Various embodiments set forth designs for integrated inductor packages for multiphase power supplies.

One embodiment of the present disclosure sets forth an integrated inductor package comprising a magnetic core, a first conductive coil coupled to the magnetic core, and a second conductive coil coupled to the magnetic core. The first conductive coil is disposed on a first side of the integrated inductor package and coupled between a first input pin and a first output pin. The second conductive coil is disposed on a second side of the integrated inductor package and coupled between a second input pin and a second output pin.

At least one technical advantage of the disclosed multiphase power supply design relative to the prior art is that, in the disclosed design, the amount of space occupied by the inductors is reduced relative to conventional approaches. In this regard, in the disclosed design, multiple inductor coils are included in an integrated inductor package that occupies less physical space on a printed circuit board than an equivalent number of the discrete inductor packages used in conventional multiphase power supply designs. Further, by reducing the amount of space occupied on a printed circuit board by the inductors in the disclosed design, the phase switches can be positioned closer on the printed circuit board closer to the load to which the phase switches deliver power, which reduces the amount of copper losses in the multiphase power supply. At least another technical advantage of the disclosed design is that inductor coils included in the integrated inductor package are magnetically coupled to one another. In this regard, the respective inductances of the inductor coils in the disclosed integrated inductor package are maintained during steady-state operation of the multiphase power supply and reduced during transient operation of the multiphase power supply, which improves the overall transient performance of the multiphase power supply. In addition, the coupled inductor coils can be arranged within the disclosed integrated inductor package such that the magnetic fields generated by the different inductor coils within the package oppose one another, which reduces the overall level of electromagnetic interference during operation relative to the levels that typically result in prior art inductor package designs. These technical advantages represent one or more technological improvements over prior art approaches.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIGS. 1A-1E illustrate perspective views of exemplar integrated inductor packages, according to various embodiments;

FIGS. 2A-2B illustrate top-down views of different exemplar integrated inductor packages, according to various embodiments;

FIGS. 3A-3C illustrate top-down views of different exemplar coil orientations that can be included in an integrated inductor package, according to various embodiments;

FIGS. 4A-4C illustrate top-down views of different exemplar magnetic coupling patterns that can be included in an integrated inductor package, according to various embodiments;

FIG. 5 illustrates a top-down view of magnetic field cancellation in an integrated inductor package, according to various embodiments;

FIG. 6 illustrates a circuit diagram of a multiphase power supply that implements multiple integrated inductor packages, according to various embodiments;

FIGS. 7A-7C illustrate top-down views of different exemplar integrated inductor packages, according to various other embodiments; and

FIG. 8 illustrates a computer system configured to implement one or more aspects of the various embodiments.

### DETAILED DESCRIPTION

In the following description, numerous specific details are set forth to provide a more thorough understanding of the embodiments of the present disclosure. However, it will be apparent to one of skill in the art that the embodiments of the present disclosure may be practiced without one or more of these specific details.

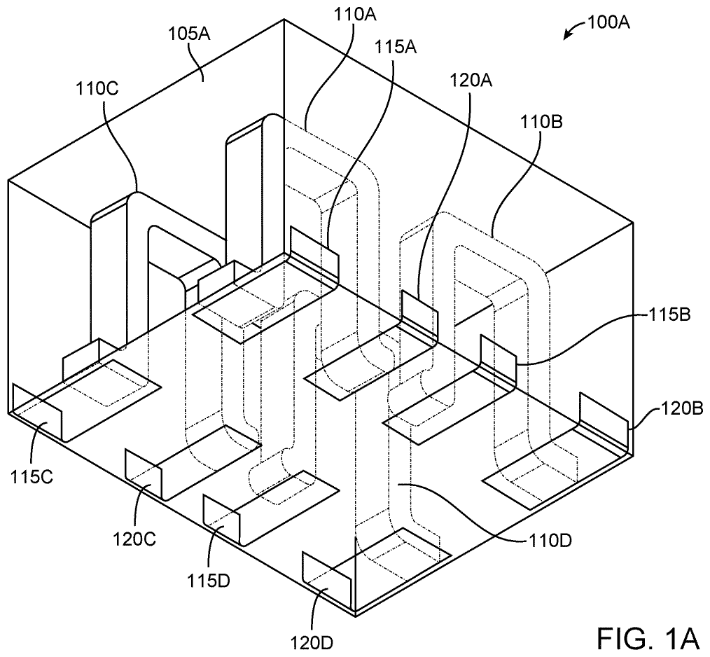

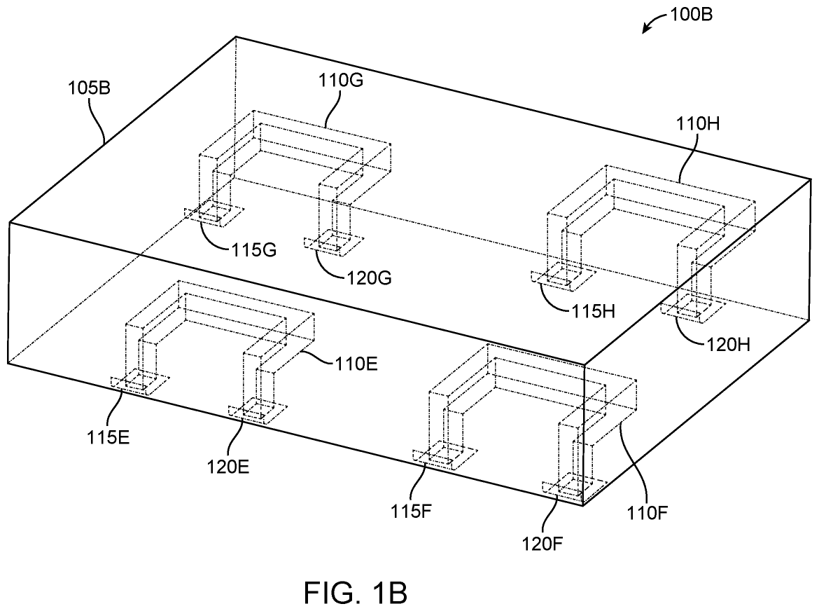

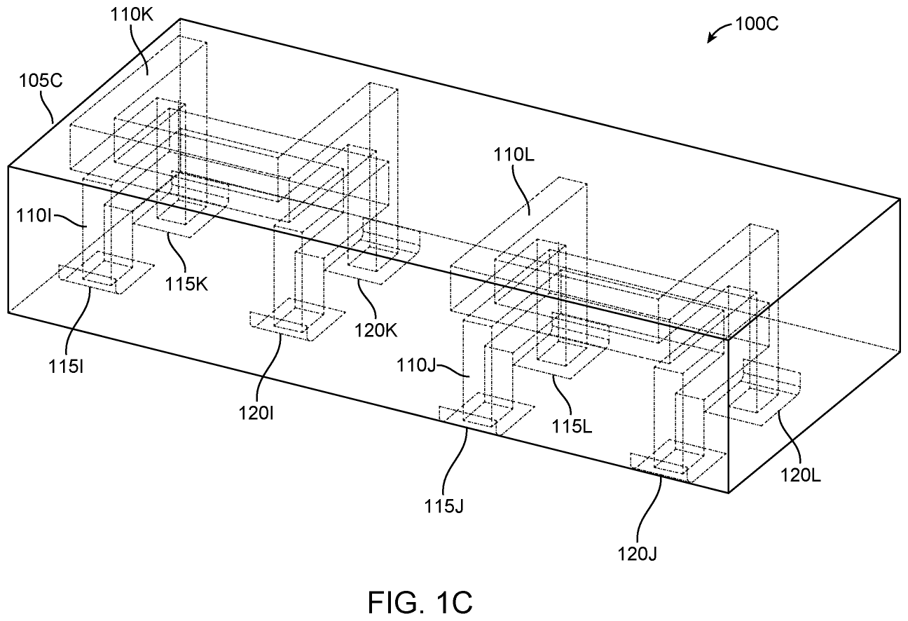

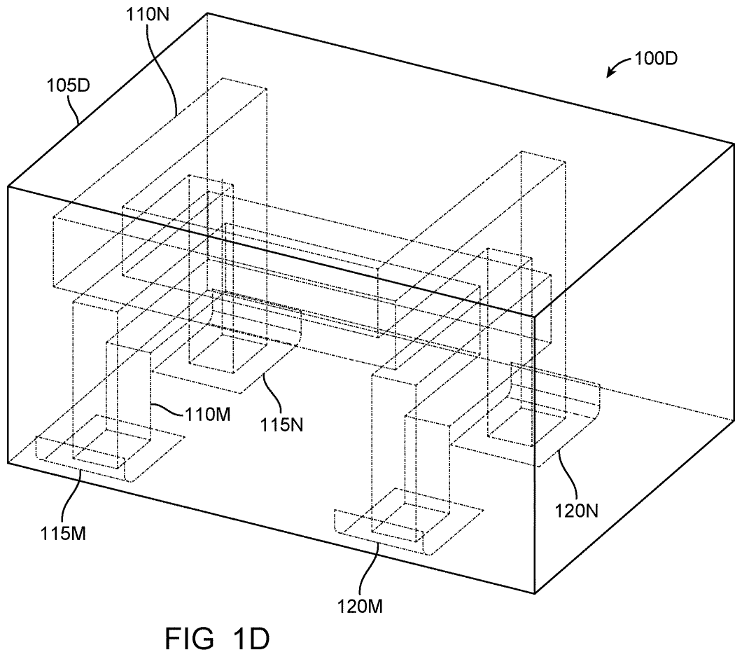

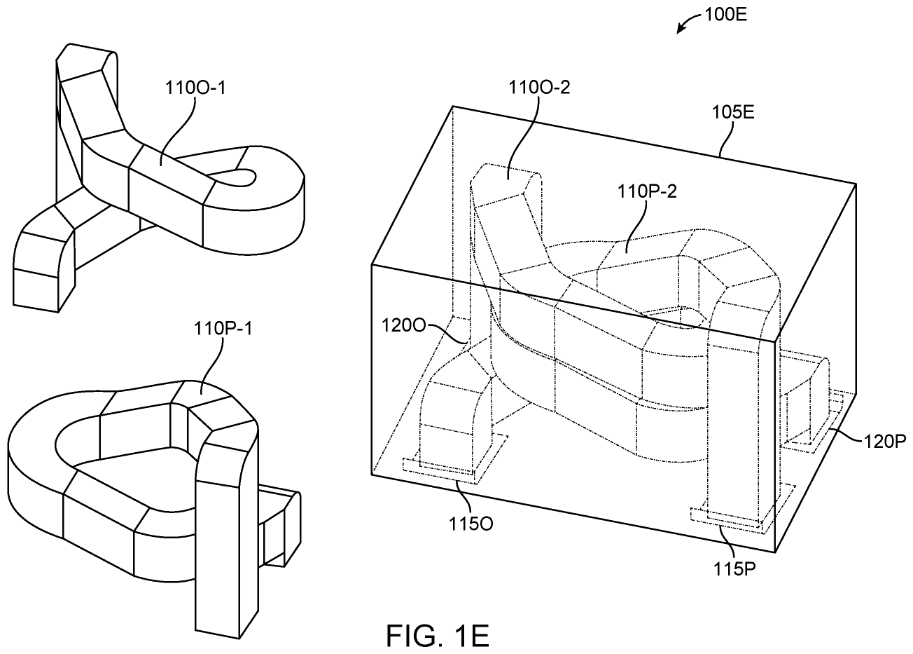

FIGS. 1A-E illustrate perspective views of exemplar integrated inductor packages 100, according to various embodiments. As shown in FIG. 1A, an integrated inductor package 100A includes a magnetic core 105A that comprises one or more alloy powder materials. In some examples, the magnetic core 105A is constructed as a single piece using one or more alloy powder materials. In some examples, the magnetic core 105A is constructed in two or more pieces using the one or more alloy powder materials. Some non-limiting examples of alloy powder materials that can be used to construct, or otherwise fabricate, the magnetic core 105A include iron-based amorphous powder, cobalt-based amorphous powder, ferrite powder, iron (Fe) powder, or some other suitable alloy powder material. As further shown in FIG. 1A, the integrated inductor package 100A includes a plurality of conductive coils 110A-110D that are assembled on, or otherwise coupled to, the magnetic core 105A. As will be described in more detail herein, a respective conductive coil 110 included in the plurality of conductive coils 110A-110D can be magnetically coupled to one or more other conductive coils 110 included in the plurality of conductive coils 110A-110D. Although the conductive coils 110 are shown have a particular structure in the illustrated example of FIG. 1A, persons skilled in the art will understand that conductive coils of other shapes and/or structures can be implemented in the integrated inductor package 100A. For example, the conductive coils 110 can be rounded, straight, rectangular, have a bent shape, have a curved shape, have a helical shape, be arranged in parallel with each other, be arranged perpendicularly with respect to each other, be arranged to overlap with each other, be intertwined with each other, or be shaped and/or arranged in some other fashion.

In the illustrated example of FIG. 1A, the integrated inductor package 100A includes four conductive coils 110A-110D. However, as will be described in more detail herein, in various embodiments, an integrated inductor package can include fewer than four conductive coils (e.g., two conductive coils or three conductive coils) or more than four conductive coils (e.g., six conductive coils, eight conductive coils, ten conductive coils, or more). Each conductive coil 110 included in the integrated inductor package 100 is electrically coupled between a respective input pin 115 and a respective output pin 120. For example, the first conductive coil 110A is electrically coupled between a first input pin 115A and a first output pin 120A, the second conductive coil 110B is electrically coupled between a second input pin 115B and a second output pin 120B, the third conductive coil 110C is electrically coupled between a third input pin 115C and a third output pin 120C, and the fourth conductive coil 110D is electrically coupled between a fourth input pin 115D and a fourth output pin 120D. The input pins 115 and output pins 120 can be implemented as conductive pins, conductive tabs, and/or other suitable conductive elements. In operation, current flows into a respective conductive coil 110 through an input pin 115 and current flows out of the respective conductive coil 110 through an output pin 120. For example, current flows into the first conductive coil 110A through the first input pin 115A and current flows out of the first conductive coil 110A through the first output pin 120A. In some examples, one or more of the output pins 120 are coupled together and/or implemented as a single output pin. Persons skilled in the art will understand that the respective positions of the input pins 115A-115D and output pins 120A-120D are provided as non-limiting examples, and that in other examples, positions of any of the respective input pins 115A-115D or output pins 120A-120D can be moved and or swapped.

As will be described in more detail herein, in some examples, the integrated inductor package 100A can be implemented in a multiphase power supply that supplies power to a load. In such examples, each conductive coil 110 included in the integrated inductor package 100A can be coupled between a respective phase switch included in the multiphase power supply and the load. For example, the first conductive coil 110A can be coupled between a first phase switch and the load such that the first input pin 115A couples the first phase switch to the first conductive coil 110A and the first output pin 120A couples the first conductive coil 110A to the load. In operation, the first phase switch outputs a first phase current that flows through the first conductive coil 110A to the load. Similarly, as another example, the second conductive coil 110B can be coupled between a second phase switch and the load such that the second input pin 115B couples the second phase switch to the second conductive coil 110B and the second output pin 120B couples the second conductive coil 110B to the load. In operation, the second phase switch outputs a second phase current that flows through the second conductive coil 110B to the load.

In the illustrated example of FIG. 1A, the first and second conductive coils 110A, 110B are arranged on a first side of the integrated inductor package 100A and the third and fourth conductive coils 110C, 110D are arranged on a second side of the integrated inductor package 100A, the second side being opposite to the first side of the integrated inductor package 100A. In addition, as shown in the illustrated example of FIG. 1A, the first conductive coil 110A is oriented in parallel with the second conductive coil 110B such that the first conductive coil 110A extends in substantially the same direction as the second conductive coil 110B. Similarly, in the illustrated example of FIG. 1A, the third conductive coil 110C is oriented in parallel with the fourth conductive coil 110D such that the third conductive coil 110C extends in substantially the same direction as the fourth conductive coil 110D. However, persons skilled in the art should understand that the arrangement and respective orientations of the conductive coils 110A-110D shown in the illustrated example of FIG. 1A are provided as just one non-limiting example. As will be described in more detail herein, the arrangement, number, and/or respective positions of the conductive coils 110 included in the integrated inductor package 100A can be changed relative to the arrangement shown in FIG. 1A such that one or more of the conductive coils 110 are moved to other positions within the integrated inductor package 100A. Similarly, the orientation of the conductive coils 110 included in the integrated inductor package 100A can be changed relative to the arrangement shown in FIG. 1A such that one or more of the conductive coils 110 are oriented at one or more offset angles relative to other conductive coils 110.

Furthermore, in the illustrated example of FIG. 1A, current flows through each of the conductive coils 110A-110D included in the integrated inductor package 100A in the same direction. For example, the direction in which current flows from the first input pin 115A through the first conductive coil 110A to the first output pin 120A is the same direction in which current flows from the second input pin 115B through the second conductive coil 110B to the second output pin 120B. As another example, direction in which current flows from the first input pin 115A through the first conductive coil 110A to the first output pin 120A is the same direction in which current flows from the third input pin 115C through the third conductive coil 110C to the third output pin 120C, and so on. However, persons skilled in the art should understand that the respective direction in which current flows through the conductive coils 110A-110D shown in the illustrated example of FIG. 1A are provided as just one non-limiting example. As will be described in more detail herein, the respective direction in which current flows through a particular conductive coil 110 included in the integrated inductor package 100A can be different than the respective direction in which current flows through another conductive coil 110 included in the integrated inductor package 100A. For example, the respective positions of the first input pin 115A and the first output pin 120A can be swapped such that the direction in which current flows through the first conductive coil 110A is reversed and opposite to the direction in which current flows through the second conductive coil 110B. In general, persons skilled in the art will understand that the positions of the respective input pin 115 and output pin 120 connected to a particular conductive coil 110 can be swapped and/or otherwise moved to change the direction in which current flows through the particular conductive coil 110 relative to the integrated inductor package 100A.

As described herein, the integrated inductor package 100 can include any number of conductive coils 110. Further, the conductive coils 110 can be rounded, straight, rectangular, have a bent shape, have a curved shape, have a helical shape, be arranged in parallel with each other, be arranged perpendicularly with respect to each other, be arranged to overlap with each other, be intertwined with each other, or be shaped and/or arranged in some other fashion. In that regard, FIGS. 1B-1E illustrate perspective views of other exemplar integrated inductor packages 100B-100E. These other exemplar integrated inductor packages 100 function substantially similar to the integrated inductor package 100A illustrated in FIG. 1A and as further described herein.

In the illustrated example of FIG. 1B, an integrated inductor package 100B includes a magnetic core 105B and a plurality of conductive coils 110E-110H that are assembled on, or otherwise coupled to, the magnetic core 105B. The first and second conductive coils 110E, 110F are arranged on a first side of the integrated inductor package 100B and the third and fourth conductive coils 110G, 110H are arranged on a second side of the integrated inductor package 100B, the second side being opposite to the first side of the integrated inductor package 100B. In addition, as shown in the illustrated example of FIG. 1B, the first conductive coil 110E is oriented in parallel with the second conductive coil 110F such that the first conductive coil 110E extends in substantially the same direction as the second conductive coil 110F. Similarly, in the illustrated example of FIG. 1B, the third conductive coil 110G is oriented in parallel with the fourth conductive coil 110H such that the third conductive coil 110G extends in substantially the same direction as the fourth conductive coil 110H.

The conductive coils 110E-110H are shown in a bent configuration. In particular, the first conductive coil 110E includes a first portion that extends from input pin 115E and a second portion that attaches to and extends substantially perpendicular from the first portion. Further, the first conductive coil 110E includes a third portion that extends from output pin 120E and a fourth portion that attaches to and extends substantially perpendicular from the third portion. The first conductive coil 110E includes a fifth portion that orthogonally attaches to the second portion and the fourth portion.

Similarly, the second conductive coil 110F includes a first portion that extends from input pin 115F and a second portion that attaches to and extends substantially perpendicular from the first portion. Further, the second conductive coil 110F includes a third portion that extends from output pin 120F and a fourth portion that attaches to and extends substantially perpendicular from the third portion. The second conductive coil 110F includes a fifth portion that orthogonally attaches to the second portion and the fourth portion.

Similarly, the third conductive coil 110G includes a first portion that extends from input pin 115G and a second portion that attaches to and extends substantially perpendicular from the first portion. Further, the third conductive coil 110G includes a third portion that extends from output pin 120G and a fourth portion that attaches to and extends substantially perpendicular from the third portion. The third conductive coil 110G includes a fifth portion that orthogonally attaches to the second portion and the fourth portion.

Similarly, the fourth conductive coil 110H includes a first portion that extends from input pin 115H and a second portion that attaches to and extends substantially perpendicular from the first portion. Further, the fourth conductive coil 110H includes a third portion that extends from output pin 120H and a fourth portion that attaches to and extends substantially perpendicular from the third portion. The fourth conductive coil 110H includes a fifth portion that orthogonally attaches to the second portion and the fourth portion.

In this manner, the bent configuration of conductive coils 110E-110H can have a lower vertical profile relative to the configuration of conductive coils 110A-110D shown in FIG. 1A. Therefore, integrated inductor package 100B can be deployed where the available vertical clearance does not accommodate the space occupied by the integrated inductor package 100A of FIG. 1A.

In the illustrated example of FIG. 1C, an integrated inductor package 100C includes a magnetic core 105C and a plurality of conductive coils 110I-110L that are assembled on, or otherwise coupled to, the magnetic core 105C. The first and second conductive coils 110I, 110J are arranged on a first side of the integrated inductor package 100C and the third and fourth conductive coils 110K, 110L are arranged on a second side of the integrated inductor package 100C, the second side being opposite to the first side of the integrated inductor package 100C. In addition, as shown in the illustrated example of FIG. 1C, the first conductive coil 110I is oriented in parallel with the second conductive coil 110J such that the first conductive coil 110I extends in substantially the same direction as the second conductive coil 110J. Similarly, in the illustrated example of FIG. 1C, the third conductive coil 110K is oriented in parallel with the fourth conductive coil 110L such that the third conductive coil 11K extends in substantially the same direction as the fourth conductive coil 110L.

The conductive coils 110I-110L are shown in a bent configuration. In particular, the first conductive coil 110I includes a first portion that extends from input pin 115I and a second portion that attaches to and extends substantially perpendicular from the first portion. Further, the first conductive coil 110I includes a third portion that extends from output pin 120I and a fourth portion that attaches to and extends substantially perpendicular from the third portion. The first conductive coil 110I includes a fifth portion that orthogonally attaches to the second portion and the fourth portion.

Similarly, the second conductive coil 110J includes a first portion that extends from input pin 115J and a second portion that attaches to and extends substantially perpendicular from the first portion. Further, the second conductive coil 110J includes a third portion that extends from output pin 120J and a fourth portion that attaches to and extends substantially perpendicular from the third portion. The second conductive coil 110J includes a fifth portion that orthogonally attaches to the second portion and the fourth portion.

Similarly, the third conductive coil 110K includes a first portion that extends from input pin 115K and a second portion that attaches to and extends substantially perpendicular from the first portion. Further, the third conductive coil 110K includes a third portion that extends from output pin 120K and a fourth portion that attaches to and extends substantially perpendicular from the third portion. The third conductive coil 110K includes a fifth portion that orthogonally attaches to the second portion and the fourth portion.

Similarly, the fourth conductive coil 110L includes a first portion that extends from input pin 115L and a second portion that attaches to and extends substantially perpendicular from the first portion. Further, the fourth conductive coil 110L includes a third portion that extends from output pin 120L and a fourth portion that attaches to and extends substantially perpendicular from the third portion. The fourth conductive coil 110L includes a fifth portion that orthogonally attaches to the second portion and the fourth portion.

With the bent configuration shown in FIG. 1C, a portion of the first conductive coil 110I overlaps with a portion of the third conductive coil 110K. Similarly, a portion of the second conductive coil 110J overlaps with a portion of the fourth conductive coil 110L. In this manner, the bent configuration of conductive coils 110I-110L can have a lower surface area footprint relative to the configuration of conductive coils 110E-110H shown in FIG. 1B. Further, the bent configuration of conductive coils 110I-110L can have a lower vertical profile relative to the configuration of conductive coils 110A-110D shown in FIG. 1A. Therefore, integrated inductor package 100C can be deployed where the available vertical clearance does not accommodate the space occupied by the integrated inductor package 100A of FIG. 1A and/or where the available surface area footprint does not accommodate the space occupied by the integrated inductor package 100B of FIG. 1B.

In the illustrated example of FIG. 1D, an integrated inductor package 100D includes a magnetic core 105D and a plurality of conductive coils 110M-110N that are assembled on, or otherwise coupled to, the magnetic core 105D. The first conductive coil 110M is arranged on a first side of the integrated inductor package 100D and the second conductive coil 110N is arranged on a second side of the integrated inductor package 100D, the second side being opposite to the first side of the integrated inductor package 100D.

The conductive coils 110M-110N are shown in a bent configuration. In particular, the first conductive coil 110M includes a first portion that extends from input pin 115M and a second portion that attaches to and extends substantially perpendicular from the first portion. Further, the first conductive coil 110M includes a third portion that extends from output pin 120M and a fourth portion that attaches to and extends substantially perpendicular from the third portion. The first conductive coil 110M includes a fifth portion that orthogonally attaches to the second portion and the fourth portion.

Similarly, the second conductive coil 110N includes a first portion that extends from input pin 115N and a second portion that attaches to and extends substantially perpendicular from the first portion. Further, the second conductive coil 110N includes a third portion that extends from output pin 120N and a fourth portion that attaches to and extends substantially perpendicular from the third portion. The second conductive coil 110N includes a fifth portion that orthogonally attaches to the second portion and the fourth portion.

With the bent configuration shown in FIG. 1D, a portion of the first conductive coil 110M overlaps with a portion of the second conductive coil 110N. In this manner, the bent configuration of conductive coils 110M-110N can have a lower surface area footprint relative to the configuration of conductive coils 110E-110H shown in FIG. 1B. Further, the bent configuration of conductive coils 110I-110L can have a lower vertical profile relative to the configuration of conductive coils 110A-110D shown in FIG. 1A. Further, the bent configuration of the two conductive coils 110M-110N can have a lower surface area footprint relative to the configuration of the four conductive coils 110I-110L shown in FIG. 1C. Therefore, integrated inductor package 100D can be deployed where two conductive coils 110 are needed, where the available vertical clearance does not accommodate the space occupied by the integrated inductor package 100A of FIG. 1A, and/or where the available surface area footprint does not accommodate the space occupied by the integrated inductor package 100B of FIG. 1B.

In some cases, pairs of conductive coils 110 can be intertwined in order to achieve a desired inductive coupling between the conductive coils 110 included in a pair of conductive coils 110. In the illustrated example of FIG. 1E, a first conductive coil 110O-1 and a second conductive coil 110P-1 are fabricated as curved structures that are configured to be intertwined with one another. When installed in a magnetic core 105E, the first conductive coil 110O-2 and the second conductive coil 110P-2 are intertwined with one another. In that regard, an integrated inductor package 100E includes a magnetic core 105E and a plurality of conductive coils 110O-110P that are assembled on, or otherwise coupled to, the magnetic core 105E. The first conductive coil 110O is arranged on a first side of the integrated inductor package 100E and the second conductive coil 110P is arranged on a second side of the integrated inductor package 100E, the second side being opposite to the first side of the integrated inductor package 100E.

The conductive coils 110O-110P are shown in an intertwined configuration. In particular, the first conductive coil 110O includes a first portion that extends from input pin 115O and a second portion that extends from output pin 120O. Similarly, the second conductive coil 110P includes a first portion that extends from input pin 115P and a second portion that extends from output pin 120P. A third portion of the first conductive coil 110O extends in a curvilinear configuration to connect the first portion extending from input pin 115O to the second portion extending from output pin 120O. Similarly, a third portion of the second conductive coil 110P extends in a curvilinear configuration to connect the first portion extending from input pin 115P to the second portion extending from output pin 120P. The third portion of the first conductive coil 110O and the third portion of the second conductive coil 110P are configured to intertwine with one another.

With the intertwined configuration shown in FIG. 1E, the first conductive coil 110O and the second conductive coil 110P can provide desirable mutual inductance characteristics relative to the configurations shown in FIGS. 1A-1D. In addition, the intertwined configuration of conductive coils 110O-110P can have a lower surface area footprint relative to the configuration of conductive coils 110 shown in FIGS. 1A-1B. Further, the bent configuration of conductive coils 110O-110P can have a lower vertical profile relative to the configuration of conductive coils 110A-110D shown in FIG. 1A. Therefore, integrated inductor package 100D can be deployed where two conductive coils 110 are needed, where the available vertical clearance does not accommodate the space occupied by the integrated inductor package 100A of FIG. 1A, where the available surface area footprint does not accommodate the space occupied by the integrated inductor package 100B of FIG. 1B, and/or where the mutual inductance provided by an intertwined configuration of conductive coils 110 is desirable.

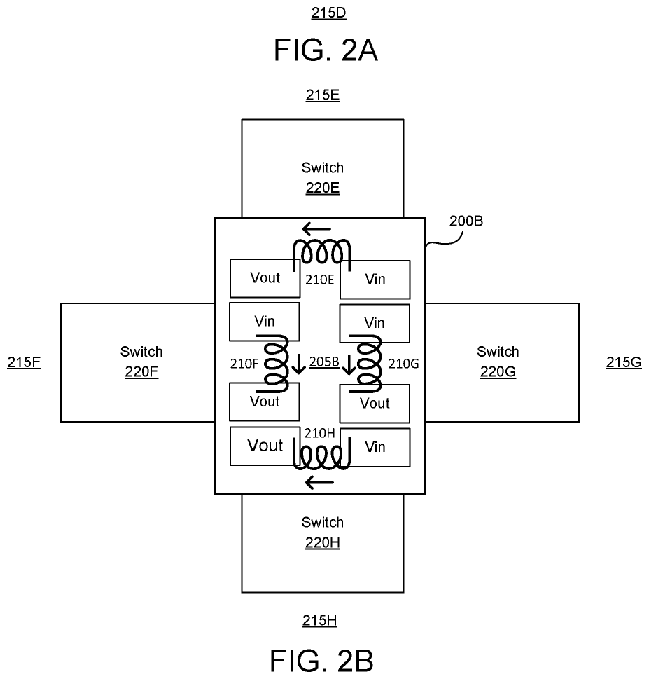

Again, persons skilled in the art should understand that the arrangement and respective orientations of the conductive coils 110 shown in the illustrated examples of FIG. 1A-1E are provided as various non-limiting examples. In addition, as further described herein, the arrangement, number, and/or respective positions of the conductive coils 110 included in the integrated inductor packages 100A-100E can be changed relative to the arrangements shown in FIGS. 1A-1E such that one or more of the conductive coils 110 are moved to other positions within the integrated inductor packages 100A-100E. Similarly, the orientation of the conductive coils 110 included in the integrated inductor packages 100A-100E can be changed relative to the arrangement shown in FIGS. 1A-1E such that one or more of the conductive coils 110 are oriented at one or more offset angles relative to other conductive coils 110. Further, the different respective configurations, arrangements, and orientations of the conductive coils 110 illustrated in FIGS. 1A-1E can be used with the exemplar integrated inductor packages shown in FIGS. 2A-7C in any combination.

FIGS. 2A-2B illustrate top-down views of different exemplar integrated inductor packages, according to various embodiments. For example, FIG. 2A illustrates a top-down view of an exemplar integrated inductor package 200A that includes a magnetic core 205A that is coupled to four conductive coils 210A-210D. Similar to the magnetic core 105 described with respect to FIGS. 1A-1E, the magnetic core 205A can be formed of one or more suitable alloy powder materials. Each of the respective conductive coils 210A-210D is coupled between a respective input pin Vᵢₙ and a respective output pin Vₒᵤₜ. As described herein with respect to FIGS. 1A-1E, a respective input pin Vᵢₙ couples a respective conductive coil 210 to a respective phase switch and a respective output pin Vₒᵤₜ couples a respective conductive coil 210 to a load. For example, the first conductive coil 210A is coupled to a first phase switch 220A via an input pin Vᵢₙ and the first conductive coil 210A is coupled to a load (not shown) via an output pin Vₒᵤₜ. As another example, the second conductive coil 210B is coupled to a second phase switch 220B via an input pin Vᵢₙ and the second conductive coil 210B is coupled to a load (not shown) via an output pin Vₒᵤₜ. As will be described in more detail herein, a respective conductive coil 210 included in the plurality of conductive coils 210A-210D can be magnetically coupled to one or more other conductive coils 210 included in the plurality of conductive coils 210A-210D.

In the illustrated example of FIG. 2A, the first conductive coil 210A and the third conductive coil 210C are arranged, or disposed, on a first side 215A of the integrated inductor package 200A. In this regard, the first phase switch 220A coupled to the first conductive coil 210A and the third phase switch 220C coupled to the third conductive coil 210C can be arranged adjacent to the first side 215A of the integrated inductor package 200A. Similarly, the second conductive coil 210B and the fourth conductive coil 210D are arranged, or disposed, on a second side 215B of the integrated inductor package 200A that is opposite to the first side 215A of the integrated inductor package 200A. In this regard, the second phase switch 220B coupled to the second conductive coil 210B and the fourth phase switch 220D coupled to the fourth conductive coil 210D can be arranged adjacent to the second side 215B of the integrated inductor package 200A.

In operation, current flows from a respective phase switch 220 into a respective conductive coil 210 via an input pin Vᵢₙ and current flows out of the respective conductive coil 210 to the load via an output pin Vₒᵤₜ. For example, current flows from the first phase switch 220A into the first conductive coil 210A via an input pin Vᵢₙ and current flows out of the first conductive coil 210A to the load via an output pin Vₒᵤₜ. The physical direction in which current flows through a particular conductive coil 210 relative to the integrated inductor package 200A corresponds to the manner in which the particular conductive coil 210 is coupled between respective input pins Vᵢₙ and output pins Vₒᵤₜ. Moreover, as current flows through a particular conductive coil 210 from the input pin Vᵢₙ to the output pin Vₒᵤₜ, the physical direction in which current flows through a particular conductive coil 210 relative to the integrated inductor package 200A corresponds to the position of the input pin Vᵢₙ relative to the position of the output pin Vₒᵤₜ.

In the illustrated example of FIG. 2A, the first conductive coil 210A is coupled to an input pin Vᵢₙ that is disposed closer to a third side 215C of the integrated inductor package 200A than the output pin Vₒᵤₜ to which the first conductive coil 210A is coupled. The first conductive coil 210A is also oriented in a direction that is parallel to the first side 215A of the integrated inductor package 200A such that the first conductive coil 210A extends between the third side 215C of the integrated inductor package 200A and the fourth side 215D of the integrated inductor package 200A. Accordingly, current flows through the first conductive coil 210A in a first direction from the third side 215C of the integrated inductor package 200A towards the fourth side 215D of the integrated inductor package 200A. The first direction relative the integrated inductor package 200A in which current flows through the first conductive coil 210A is indicated by an arrow that points from the third side 215C of the integrated inductor package 200A towards the fourth side 215D of the integrated inductor package 200A. In the illustrated example of FIG. 2A, current also flows through the third conductive coil 210C in the first direction relative to the integrated inductor package 200A.

In contrast, current flows through the second conductive coil 210B in a second direction relative to the integrated inductor package 200A that is opposite to the first direction relative to the integrated inductor package 200A. For example, in the illustrated example of FIG. 2A, the second conductive coil 210B is coupled to an input pin Vᵢₙ that is disposed closer to the fourth side 215D of the integrated inductor package 200A than the output pin Vₒᵤₜ to which the second conductive coil 210B is coupled. The second conductive coil 210B is also oriented in a direction that is parallel to the second side 215B of the integrated inductor package 200A such that the second conductive coil 210B extends between the third side 215C of the integrated inductor package 200A and the fourth side 215D of the integrated inductor package 200A. Accordingly, current flows through the second conductive coil 210B in a second direction from the fourth side 215D of the integrated inductor package 200A towards the third side 215C of the integrated inductor package 200A. The second direction relative the integrated inductor package 200A in which current flows through the second conductive coil 210B is indicated by an arrow that points from the fourth side 215D of the integrated inductor package 200A towards the third side 215C of the integrated inductor package 200A. In the illustrated example of FIG. 2A, current also flows through the fourth conductive coil 210D in the second direction relative to the integrated inductor package 200A.

Persons skilled in the art will understand that the respective directions relative to the integrated inductor package 200A in which current flows through the conductive coils 210A-210D are provided as non-limiting examples. Moreover, persons skilled in the art will understand that, in some examples, the direction relative to the integrated inductor package 200A in which current flows through a particular conductive coil 210 can be changed by rearranging the respective positions of the input pins Vᵢₙ and output pins Vₒᵤₜ between which the particular conductive coil 210 is coupled. As will be described in more detail herein, the direction in which current flows through a respective conductive coil 210 included in the plurality of conductive coils 210A-210D can be adjusted to change an amount by which the respective conductive coil 210 is magnetically coupled with one or more other conductive coils 210 in the plurality of conductive coils 210A-210D. Furthermore, although the magnetic core 205A included in the integrated inductor package 200A is shown to have a generally rectangular shape, persons skilled in the art will understand that in some examples, the magnetic core 205A can be designed to have a different shape such as, but not limited to, a rounded shape, a cross-shape, an I-shape, an octagonal shape, or some other type of shape. In some examples, the shape of the magnetic core 205A included in the integrated inductor package 200A can be selected based on the spatial constraints of the circuit, such as a multiphase power supply, and/or the device in which the integrated inductor package 200A is implemented.

FIG. 2B illustrates a top-down view of an exemplar integrated inductor package 200B that includes a magnetic core 205B that is coupled to four conductive coils 210E-210H. Similar to the magnetic core 105 described with respect to FIGS. 1A-1E, the magnetic core 205B can be formed of one or more suitable alloy powder materials. Each of the respective conductive coils 210E-210H is coupled between a respective input pin Vᵢₙ and a respective output pin Vₒᵤₜ. In the illustrated example of FIG. 2B, the first conductive coil 210E is arranged, or disposed, on a first side 215E of the integrated inductor package 200B, the second conductive coil 210F is arranged, or disposed, on a second side 215F of the integrated inductor package 200B, the third conductive coil 210G is arranged, or disposed, on a third side 215G of the integrated inductor package 200B, and the fourth conductive coil 210H is arranged, or disposed, on a fourth side 215H of the integrated inductor package 200B. In this regard, the first phase switch 220E coupled to the first conductive coil 210E can be disposed adjacent to the first side 215E of the integrated inductor package 200B, the second phase switch 220F coupled to the second conductive coil 210F can be disposed adjacent to the second side 215F of the integrated inductor package 200B, the third phase switch 220G coupled to the third conductive coil 210G can be disposed adjacent to the third side 215G of the integrated inductor package 200B, and the fourth phase switch 220H coupled to the fourth conductive coil 210H can be disposed adjacent the fourth side 215H of the integrated inductor package 200B. The first side 215E of the integrated inductor package 200B is opposite to the fourth side 215H of the integrated inductor package 200B, and the second side 215F of the integrated inductor package 200B is opposite to the third side 215G of the integrated inductor package 200B.

In the illustrated example of FIG. 2B, the first conductive coil 210E is coupled to an input pin Vᵢₙ that is disposed closer to a third side 215G of the integrated inductor package 200B than the output pin Vₒᵤₜ to which the first conductive coil 210E is coupled. The first conductive coil 210E is also oriented in a direction that is parallel to the first side 215E of the integrated inductor package 200B such that the first conductive coil 210E extends between the third side 215G of the integrated inductor package 200B and the second side 215F of the integrated inductor package 200B. Accordingly, current flows through the first conductive coil 210E in a first direction from the third side 215G of the integrated inductor package 200B towards the second side 215F of the integrated inductor package 200B. The first direction relative to the integrated inductor package 200B in which current flows through the first conductive coil 210E is indicated by an arrow that points from the third side 215G of the integrated inductor package 200B towards the second side 215F of the integrated inductor package 200B. In the illustrated example of FIG. 2B, current also flows through the fourth conductive coil 210H in the first direction relative to the integrated inductor package 200B.

In contrast, current flows through the second conductive coil 210F in a second direction relative to the integrated inductor package 200B that is perpendicular to the first direction relative to the integrated inductor package 200B. For example, in the illustrated example of FIG. 2B, the second conductive coil 210F is coupled to an input pin Vᵢₙ that is disposed closer to the first side 215E of the integrated inductor package 200B than the output pin Vₒᵤₜ to which the second conductive coil 210F is coupled. The second conductive coil 210F is also oriented in a direction that is parallel to the second side 215F of the integrated inductor package 200B such that the second conductive coil 210F extends between the first side 215E of the integrated inductor package 200B and the fourth side 215H of the integrated inductor package 200B. Accordingly, current flows through the second conductive coil 210F in a second direction from the first side 215E of the integrated inductor package 200B towards the fourth side 215H of the integrated inductor package 200B. The second direction relative the integrated inductor package 200B in which current flows through the second conductive coil 210F is indicated by an arrow that points from the first side 215E of the integrated inductor package 200B towards the fourth side 215H of the integrated inductor package 200B. In the illustrated example of FIG. 2B, current also flows through the third conductive coil 210G in the second direction relative to the integrated inductor package 200B.

Persons skilled in the art will understand that the respective directions relative to the integrated inductor package 200B in which current flows through the conductive coils 210E-210H are provided as non-limiting examples. Moreover, persons skilled in the art will understand that, in some examples, the direction relative to the integrated inductor package 200B in which current flows through a particular conductive coil 210 can be changed by rearranging the respective positions of the input pins Vᵢₙ and output pins Vₒᵤₜ between which the particular conductive coil 210 is coupled. As will be described in more detail herein, the direction in which current flows through a respective conductive coil 210 included in the plurality of conductive coils 210E-210H can be adjusted to change an amount by which the respective conductive coil 210 is magnetically coupled with one or more other conductive coils 210 in the plurality of conductive coils 210E-210H. Furthermore, although the magnetic core 205B included in the integrated inductor package 200B is shown to have a generally rectangular shape, persons skilled in the art will understand that in some examples, the magnetic core 205B can be designed to have a different shape such as, but not limited to, a rounded shape, a cross-shape, an I-shape, an octagonal shape, or some other type of shape. In some examples, the shape of the magnetic core 205B included in the integrated inductor package 200B can be selected based on the spatial constraints of the circuit, such as a multiphase power supply, and/or the device in which the integrated inductor package 200B is implemented.

In the illustrated examples of FIGS. 2A and 2B, the conductive coils 210A-210D and 210E-210H are arranged in parallel with and/or perpendicular to the respective sides 215A-215D and 215E-215H of the integrated inductor packages 200A, 200B. For example, in the illustrated example of FIG. 2A, each of the conductive coils 210A-210D are oriented in parallel with the first and second sides 215A, 215B of the integrated inductor package 200A and oriented perpendicularly to the third and fourth sides 215C, 215D of the integrated inductor package 200A. As another example, in the illustrated example of FIG. 2B, the first and fourth conductive coils 210E, 210H are oriented in parallel with the first and fourth sides 215E, 215H of the integrated inductor package 200B and oriented perpendicularly to the second and third sides 215F, 215G of the integrated inductor package 200B. Similarly, in the illustrated example of FIG. 2B, the second and third conductive coils 210F, 210G are oriented in parallel with the second and third sides 215F, 215G of the integrated inductor package 200B and oriented perpendicularly to the first and fourth sides 215E, 215H of the integrated inductor package 200B. However, persons skilled in the art will understand that, in some examples, a conductive coil included in an integrated inductor package can be oriented at a different angle relative to one or more sides of the integrated inductor package. For example, a conductive coil included in an integrated inductor package can be oriented diagonally, not in parallel with or perpendicular to, one or more sides of the integrated inductor package.

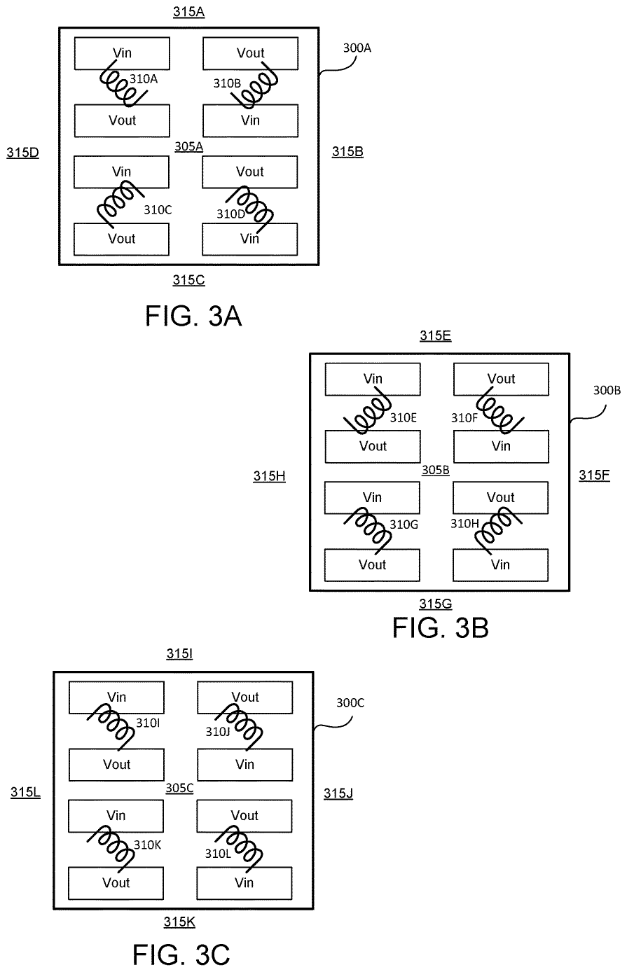

FIGS. 3A-3C illustrate top-down views of different exemplar coil orientations that can be included in an integrated inductor package, according to various embodiments. For example, FIG. 3A illustrates a top-down view of an exemplar integrated inductor package 300A that includes a magnetic core 305A that is coupled to four conductive coils 310A-310D arranged in an X-shaped coil orientation. As shown in FIG. 3A, in the X-shaped coil orientation, the first conductive coil 310A is oriented diagonally with respect to the sides 315A-315D of the integrated inductor package 300A. For example, the first conductive coil 310A is oriented at a 45 degree angle with respect to one or more sides 315A-315D of the integrated inductor package 300A. Furthermore, in the X-shaped coil orientation, the first conductive coil 310A is oriented in parallel with the fourth conductive coil 310D and is oriented perpendicularly to the second and third conductive coils 310B, 310C. Stated another way, the first conductive coil 310A is oriented at an angle of zero degrees relative to the fourth conductive coil 310D and at an angle of 90 degrees relative to the second and third conductive coils 310B, 310C. As indicated by the name, when viewed from a top-down view, conductive coils 310A-310D arranged in an X-shaped coil orientation form an “X.”

FIG. 3B illustrates a top-down view of an exemplar integrated inductor package 300B that includes a magnetic core 305B that is coupled to four conductive coils 310E-310H arranged in a diamond-shaped coil orientation. As shown in FIG. 3B, in the diamond-shaped coil orientation, the first conductive coil 310E is oriented diagonally with respect to the sides 315E-315H of the integrated inductor package 300B. For example, the first conductive coil 310E is oriented at a 45 degree angle with respect to one or more sides 315E-315H of the integrated inductor package 300B. Furthermore, in the diamond-shaped coil orientation, the first conductive coil 310E is oriented in parallel with the fourth conductive coil 310H and is oriented perpendicularly to the second and third conductive coils 310F, 310G. Stated another way, the first conductive coil 310E is oriented at an angle of zero degrees relative to the fourth conductive coil 310H and at an angle of 90 degrees relative to the second and third conductive coils 310F, 310G. As indicated by the name, when viewed from a top-down view, conductive coils 310E-310H arranged in diamond-shaped coil orientation form a diamond. When compared to conductive coils 310A-310D arranged in the X-shaped coil orientation, conductive coils 310E-310H arranged in the diamond-shaped orientation are rotated by a magnitude of 90 degrees with respect to the counterpart conductive coils 310A-310D arranged in in the X-shaped coil orientation. For example, the first conductive coil 310E included in a diamond-shaped coil orientation is rotated by 90 degrees relative to the first conductive coil 310A included in an X-shaped coil orientation. Similarly, the second conductive coil 310F included in a diamond-shaped coil orientation is rotated by −90 degrees relative to the second conductive coil 310B included in an X-shaped coil orientation.

FIG. 3C illustrates a top-down view of an exemplar integrated inductor package 300C that includes a magnetic core 305C that is coupled to four conductive coils 310I-310L arranged in a slope-shaped coil orientation. As shown in FIG. 3C, in the slope-shaped coil orientation, the first conductive coil 310I is oriented diagonally with respect to the sides 315I-315L of the integrated inductor package 300C. For example, the first conductive coil 310I is oriented at a 45 degree angle with respect to one or more sides 315I-315L of the integrated inductor package 300C. Furthermore, in the slope-shaped coil orientation, the first conductive coil 310I is oriented in parallel with the second, third, and fourth conductive coils 310J-310L. Persons skilled in the art will understand that the exemplar coil orientations shown in FIGS. 3A-3C are provided in non-limiting examples and that integrated inductor packages disclosed herein can be implemented using other coil orientations.

As described herein, the conductive coils that are coupled to the same magnetic core in an integrated inductor package can be magnetically coupled to each other. The amount by which a particular conductive coil included in an integrated inductor package is magnetically coupled to another conductive coil included in the integrated inductor package can be dependent on the direction in which current flows through the particular conductive coil, the position of the particular conductive coil relative to the another conductive coil in the integrated inductor package, and/or the orientation of the particular conductive coil relative to the another conductive coil in the integrated inductor package. By controlling the amount by which a particular conductive coil include in an integrated inductor package is magnetically coupled to one or more other conductive coils in the integrated inductor package, the amount by which the respective inductance of the conductive coils in the integrated inductor package decreases during transient operation of a multiphase power supply can be controlled. In this regard, conductive coils in the integrated inductor package can be designed to have smaller inductance values thereby improving the transient performance of the multiphase power supply that implements the integrated inductor package.

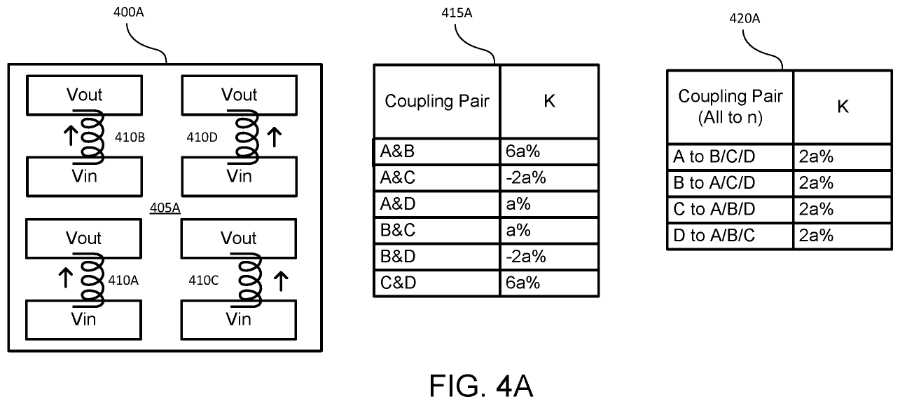

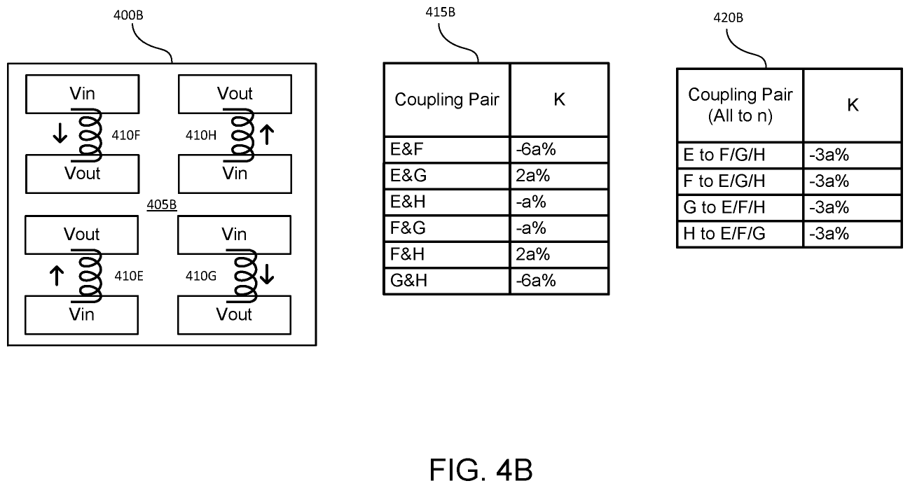

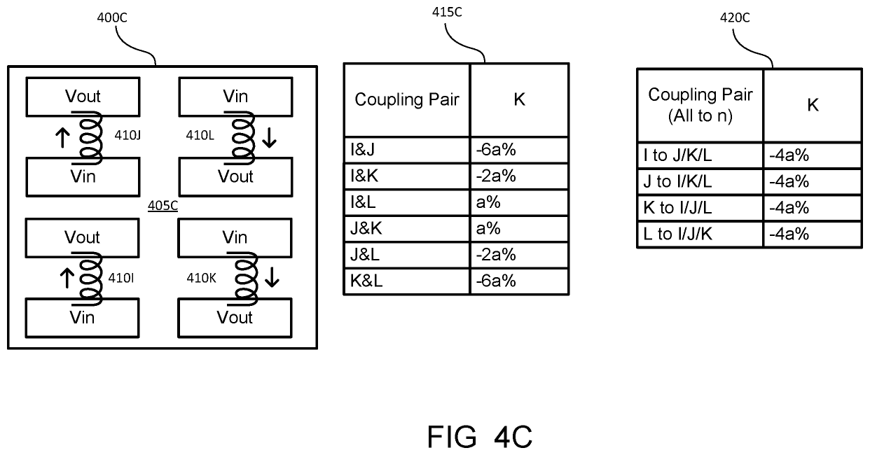

FIGS. 4A-4C illustrate top-down views of different exemplar magnetic coupling patterns that can be included in an integrated inductor package, according to various embodiments. For example, FIG. 4A illustrates a top-down view of an exemplar integrated inductor package 400A that includes a magnetic core 405A that is coupled to four conductive coils 410A-410D arranged in a first magnetic coupling pattern. The respective direction in which current flows through a particular conductive coil 410 is indicated by an arrow next to the particular conductive coil 410. As indicated by the upward facing arrows, current flows through each of the four conductive coils 410A-410D in the same direction when the conductive coils 410A-410D are arranged in the first magnetic coupling pattern. That is, the direction in which current flows through the first conductive coil 410A is the same as the respective directions in which current flows through the second conductive coil 410B, the third conductive coil 410C, and the fourth conductive coil 410D when the conductive coils 410A-410D are arranged in the first magnetic coupling pattern.

FIG. 4A further illustrates a first table 415A and a second table 420A. The first table 415A includes the respective coupling factor K between each of the conductive coils 410A-410D arranged in the first magnetic coupling pattern. For example, as indicated by the first table 415A, the first conductive coil 410A is magnetically coupled with the second conductive coil 410B by a coupling factor of 6a %, the first conductive coil 410A is magnetically coupled with the third conductive coil 410C by a coupling factor of −2a %, and the first conductive coil 410A is magnetically coupled with the fourth conductive coil 410D by a coupling factor of −a %. As further indicated by the first table 415A, the second conductive coil 410B is magnetically coupled with the third conductive coil 410C by a coupling factor of −a %, the second conductive coil 410B is magnetically coupled with the fourth conductive coil 410D by a coupling factor of 31 2a %, and the third conductive coil 410C is magnetically coupled with the fourth conductive coil 410D by a coupling factor of 6a %.

The second table 420A includes the respective combined coupling factor K between a particular conductive coil 410 and all of the other conductive coils 410 arranged in the first magnetic coupling pattern. For example, as indicated by the second table 420A, the first conductive coil 410A is magnetically coupled with the second conductive coil 410B, the third conductive coil 410C, and the fourth conductive coil 410D by a combined coupling factor of 2a %. Similarly, as indicated by the second table 420A, the second conductive coil 410B is magnetically coupled with the first conductive coil 410A, the third conductive coil 410C, and the fourth conductive coil 410D by a combined coupling factor of 2a %. Furthermore, the third conductive coil 410C is magnetically coupled with the first conductive coil 410A, the second conductive coil 410B, and the fourth conductive coil 410D by a combined coupling factor of 2a %. The fourth conductive coil 410D is magnetically coupled with the first conductive coil 410A, the second conductive coil 410B, and the third conductive coil 410C by a combined coupling factor of 2a %. Persons skilled in the art will understand that values of the coupling factors included in the first and second tables 415A, 420A are provided as non-limiting examples, and that in other examples, the conductive coils 410 included in integrated inductor package 400A can be arranged and/or designed to be magnetically coupled by other amounts not included in the first and second tables 415A, 420A.

FIG. 4B illustrates a top-down view of an exemplar integrated inductor package 400B that includes a magnetic core 405B that is coupled to four conductive coils 410E-410H arranged in a second magnetic coupling pattern. The respective direction in which current flows through a particular conductive coil 410 is indicated by an arrow next to the particular conductive coil 410. As indicated by the upward facing arrows, current flows through the first conductive coil 410E in the same direction in which current flows through the fourth conductive coil 410H, which is disposed within the integrated inductor package 400B diagonally across from the first conductive coil 410E. As indicated by downward facing arrows, current flows through the second conductive coil 410F in the same direction in which current flows through the third conductive coil 410G, which is disposed within the integrated inductor package 400B diagonally across from the second conductive coil 410F. As further indicated by the arrows in FIG. 4B, the direction in which current flows through the first and fourth conductive coils 410E, 410H is opposite to the direction in which current flows through the second and third conductive coils 410F, 410G.

FIG. 4B further illustrates a first table 415B and a second table 420B. The first table 415B includes the respective coupling factor K between each of the conductive coils 410E-410H arranged in the second magnetic coupling pattern. For example, as indicated by the first table 415B, the first conductive coil 410E is magnetically coupled with the second conductive coil 410F by a coupling factor of −6a %, the first conductive coil 410E is magnetically coupled with the third conductive coil 410G by a coupling factor of 2a %, and the first conductive coil 410E is magnetically coupled with the fourth conductive coil 410H by a coupling factor of −a%. As further indicated by the first table 415B, the second conductive coil 410F is magnetically coupled with the third conductive coil 410G by a coupling factor of −a%, the second conductive coil 410F is magnetically coupled with the fourth conductive coil 410H by a coupling factor of 2a %, and the third conductive coil 410G is magnetically coupled with the fourth conductive coil 410H by a coupling factor of −6a %.

The second table 420B includes the respective combined coupling factor K between a particular conductive coil 410 and all of the other conductive coils 410 arranged in the second magnetic coupling pattern. For example, as indicated by the second table 420B, the first conductive coil 410E is magnetically coupled with the second conductive coil 410F, the third conductive coil 410G, and the fourth conductive coil 410H by a combined coupling factor of −3a %. Similarly, as indicated by the second table 420B, the second conductive coil 410F is magnetically coupled with the first conductive coil 410E, the third conductive coil 410G, and the fourth conductive coil 410H by a combined coupling factor of −3a %. Furthermore, the third conductive coil 410G is magnetically coupled with the first conductive coil 410E, the second conductive coil 410F, and the fourth conductive coil 410H by a combined coupling factor of −3a %. The fourth conductive coil 410H is magnetically coupled with the first conductive coil 410E, the second conductive coil 410F, and the third conductive coil 410G by a combined coupling factor of −3a %. Persons skilled in the art will understand that values of the coupling factors included in the first and second tables 415B, 420B are provided as non-limiting examples, and that in other examples, the conductive coils 410 included in integrated inductor package 400B can be arranged and/or designed to be magnetically coupled by other amounts not included in the first and second tables 415B, 420B.

FIG. 4C illustrates a top-down view of an exemplar integrated inductor package 400C that includes a magnetic core 405C that is coupled to four conductive coils 410I-410L arranged in a third magnetic coupling pattern. The respective direction in which current flows through a particular conductive coil 410 is indicated by an arrow next to the particular conductive coil 410. As indicated by the upward facing arrows, current flows through the first conductive coil 410I in the same direction which current flows through the second conductive coil 410J, which is disposed within the integrated inductor package 400B in line with the first conductive coil 410I. As indicated by downward facing arrows, current flows through the third conductive coil 410K in the same direction in which current flows through the fourth conductive coil 410L, which is disposed within the integrated inductor package 400B in line with the third conductive coil 410K. As further indicated by the arrows in FIG. 4C, the direction in which current flows through the first and second conductive coils 410I, 410J is opposite to the direction in which current flows through the third and fourth conductive coils 410K, 410L.

FIG. 4C further illustrates a first table 415C and a second table 420C. The first table 415C includes the respective coupling factor K between each of the conductive coils 410I-410L arranged in the third magnetic coupling pattern. For example, as indicated by the first table 415C, the first conductive coil 410I is magnetically coupled with the second conductive coil 410J by a coupling factor of −6a %, the first conductive coil 410I is magnetically coupled with the third conductive coil 410K by a coupling factor of −2a %, and the first conductive coil 410I is magnetically coupled with the fourth conductive coil 410L by a coupling factor of a %. As further indicated by the first table 415C, the second conductive coil 410J is magnetically coupled with the third conductive coil 410K by a coupling factor of a %, the second conductive coil 410J is magnetically coupled with the fourth conductive coil 410L by a coupling factor of −2a %, and the third conductive coil 410K is magnetically coupled with the fourth conductive coil 410L by a coupling factor of −6a %.

The second table 420C includes the respective combined coupling factor K between a particular conductive coil 410 and all of the other conductive coils 410 arranged in the third magnetic coupling pattern. For example, as indicated by the second table 420C, the first conductive coil 410I is magnetically coupled with the second conductive coil 410J, the third conductive coil 410K, and the fourth conductive coil 410L by a combined coupling factor of −4a %. Similarly, as indicated by the second table 420C, the second conductive coil 410J is magnetically coupled with the first conductive coil 410I, the third conductive coil 410K, and the fourth conductive coil 410L by a combined coupling factor of −4a %. Furthermore, the third conductive coil 410K is magnetically coupled with the first conductive coil 410I, the second conductive coil 410J, and the fourth conductive coil 410L by a combined coupling factor of −4a %. The fourth conductive coil 410L is magnetically coupled with the first conductive coil 410I, the second conductive coil 410J, and the third conductive coil 410K by a combined coupling factor of −4a %. Persons skilled in the art will understand that values of the coupling factors included in the first and second tables 415C, 420C are provided as non-limiting examples, and that in other examples, the conductive coils 410 included in integrated inductor package 400C can be arranged and/or designed to be magnetically coupled by other amounts not included in the first and second tables 415C, 420C.

When compared to the first and second magnetic coupling patterns, conductive coils 410I-410L arranged in the third magnetic coupling pattern illustrated in FIG. 4C experience the lowest equivalent inductance in operation. In this regard, the conductive coils 410I-410L provide the best transient performance, as the maximum voltage output by the integrated inductor package 400C is reduced and ripple current is low.

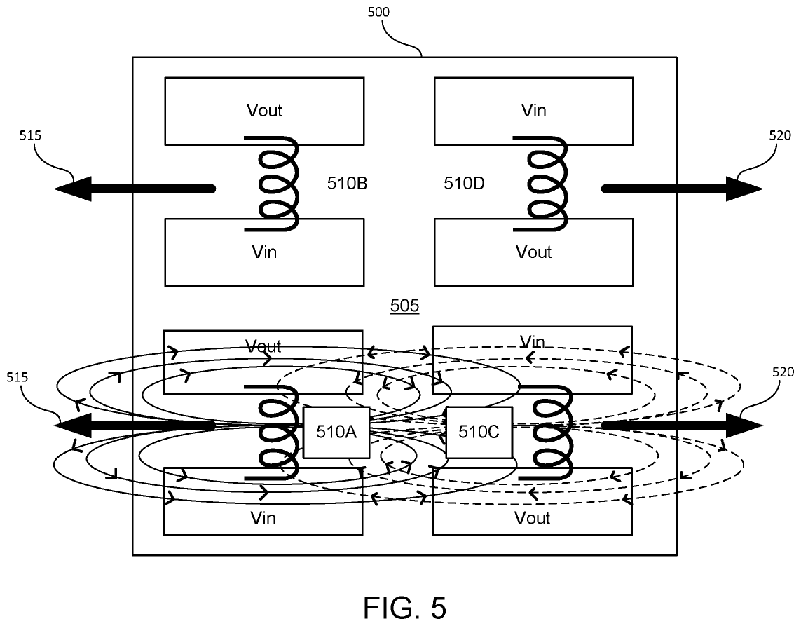

In addition to improving the transient response, conductive coils can be arranged within an integrated inductor package to reduce electromagnetic interference (EMI) during operation of a multiphase power supply that implements the integrated inductor package. FIG. 5 illustrates a top-down view of magnetic field cancellation in an integrated inductor package 500, according to various embodiments. As shown, the integrated inductor package 500 includes a magnetic core 505 that is coupled to four conductive coils 510A-510D arranged in the third magnetic coupling pattern described above with respect to FIG. 4C. Accordingly, the direction in which current flows through the first conductive coil 510A is opposite to the direction in which current flows through the third conductive coil 510C that is disposed adjacent to the first conductive coil 510A. In this regard, the direction in which a magnetic field lines emanate from the first conductive coil 510A is opposite to the direction in which magnetic field lines emanate from the third conductive coil 510C.

For example, as shown in FIG. 5, the first conductive coil 510A generates a magnetic field in which magnetic field lines (solid) emanate from the first conductive coil 510A in a first direction 515 (e.g., to the left). The third conductive coil 510C generates a magnetic field in which magnetic field lines (dashed) emanate from the third conductive coil 510C in a second direction 520 (e.g., to the right) that is opposite to the first direction. Accordingly, the magnetic field generated by the first conductive coil 510A opposes the magnetic field generated by the third conductive coil 510C, thereby reducing EMI during operation of the multiphase power supply in which the integrated inductor package 500 is integrated.

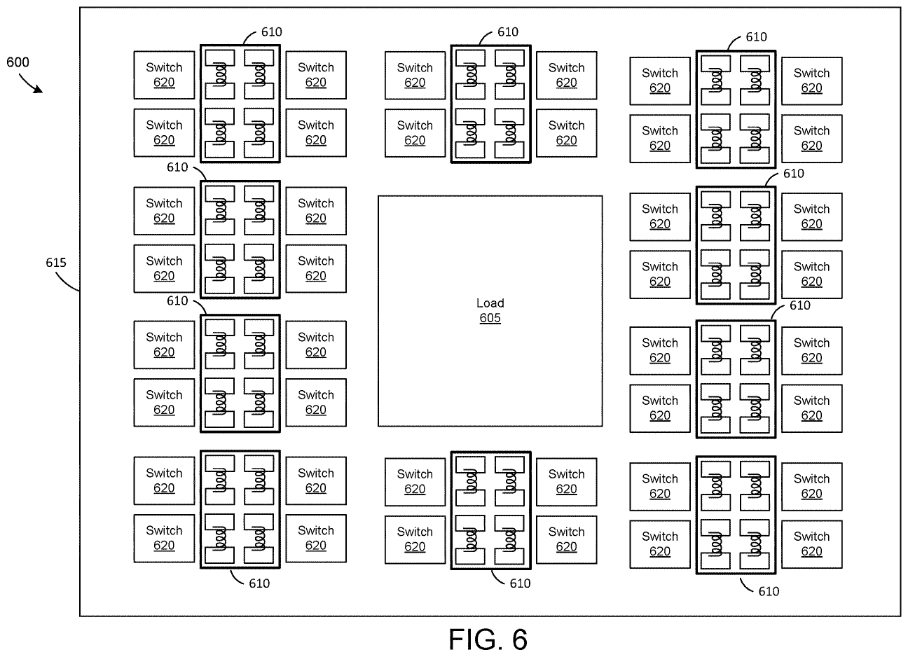

The various integrated inductor packages described herein with respect to FIGS. 1-5 can be implemented in a multiphase power supply that delivers power to a load. FIG. 6 illustrates a circuit diagram of a multiphase power supply 600 that implements multiple integrated inductor packages, according to various embodiments. In operation, the multiphase power supply 600 provides power to a load 605. The load 605 can be, for example, an electronic component such as a processor, memory, an ASIC, and/or an FPGA included in a high-performance computing system or device.

As shown in FIG. 6, the multiphase power supply 600 includes a plurality of integrated inductor packages 610 that are arranged on a printed circuit board (PCB) 615 around the load 605. In the illustrated example of FIG. 6, each integrated inductor package 610 includes four conductive coils. However, persons skilled in the art will understand that in some examples, integrated inductor packages that include more or fewer than four conductive coils can be implemented in the multiphase power supply 600. In some examples, the integrated inductor packages 610 are implemented using one or more of the integrated inductor packages 100A-100E described herein with respect to FIGS. 1A-1E, the integrated inductor packages 200A, 200B described herein with respect to FIGS. 2A, 2B, the integrated inductor packages 300A-300C described herein with respect to FIGS. 3A-3C, the integrated inductor packages 400A-400C described herein with respect to FIGS. 4A-4C, the integrated inductor package 500 described herein with respect to FIG. 5, and/or some other integrated inductor package.

As further shown in FIG. 6, the multiphase power supply 600 includes a plurality of phase switches 620, which can be implemented as MOSFETs or similar switching devices, that deliver power to the load 605 via the integrated inductor packages 610. For example, each phase switch 620 is coupled to the load 605 via a respective conductive coil included in an integrated inductor package 610. In operation, when a particular phase switch 620 is turned ON, the particular phase switch 620 outputs phase current that flows through the respective conductive coil in the integrated inductor package 610 to the load 605. The phase switches 620 can be controlled in accordance with a pulse-width-modulated (PWM) control scheme or any other suitable control scheme for delivering multiphase power to a load.

As each integrated inductor package 610 in the multiphase power supply 600 includes four conductive coils, four corresponding phase switches 620 are arranged on the PCB 615 in close proximity to each integrated inductor package 610. In the illustrated example of FIG. 6, each integrated inductor package 610 includes two conductive coils disposed on a first side of the integrated inductor package 610 and two conductive coils disposed on an opposite, second side of the integrated inductor package 610. In this regard, two phase switches 620 are arranged adjacent to the first side of each integrated inductor package 610, and two phase switches 620 are arranged adjacent to the opposite, second side of each integrated inductor package 610 in the illustrated example of FIG. 6. Moreover, the phase switches 620 arranged adjacent to the first side of an integrated inductor package 610 are coupled to the conductive coils disposed on the first side of the integrated inductor package 610 and the phase switches arranged adjacent to the second side of the integrated inductor package 610 are coupled to the conductive coils disposed on the second side of the integrated inductor package 610. When the integrated inductor packages 610 and corresponding phase switches 620 are arranged on the PCB 615 around the load 605 in the manner illustrated in FIG. 6, the respective lengths of the current paths from the phase switches 620 through the integrated inductor packages 610 to the load 605 can be significantly reduced thereby decreasing the copper losses in the multiphase power supply 600 relative to conventional approaches.

Persons skilled in the art will understand that arrangement of integrated inductor packages 610 and phases switches 620 shown in FIG. 6 is provided as a non-limiting example. Moreover, persons skilled in the art will understand that, in other examples, integrated inductor packages 610 and phases switches 620 can be arranged in a different manner. In some examples, the arrangement of integrated inductor packages 610 and phase switches 620 can be designed based on the shape of the PCB 615, the position and/or type of the load 605 that is powered by the multiphase power supply 600, and/or the geometric constraints of the computing system and/or device in which the multiphase power supply 600 is implemented.

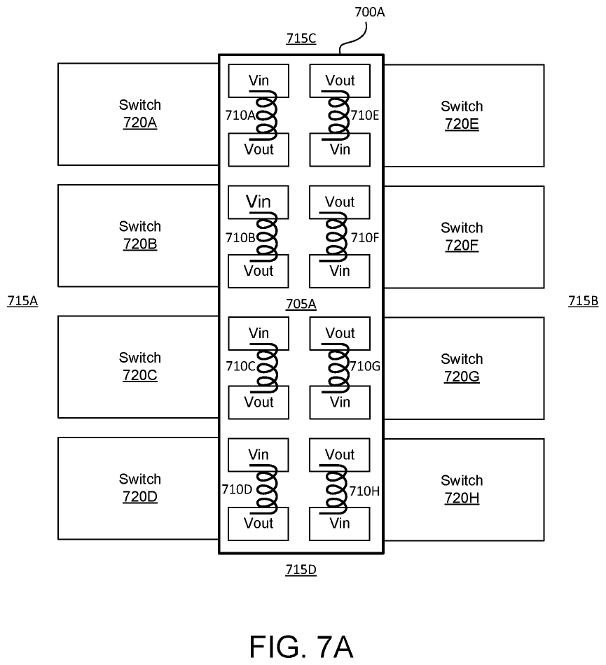

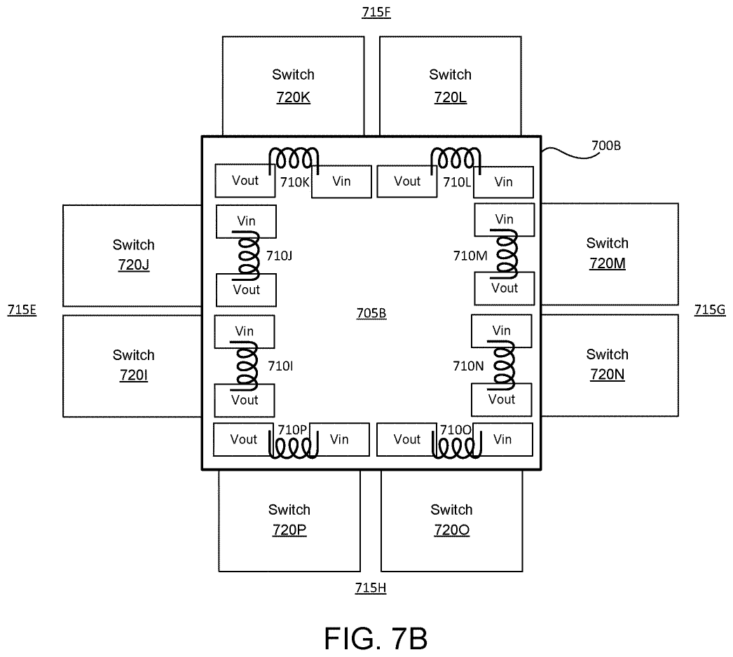

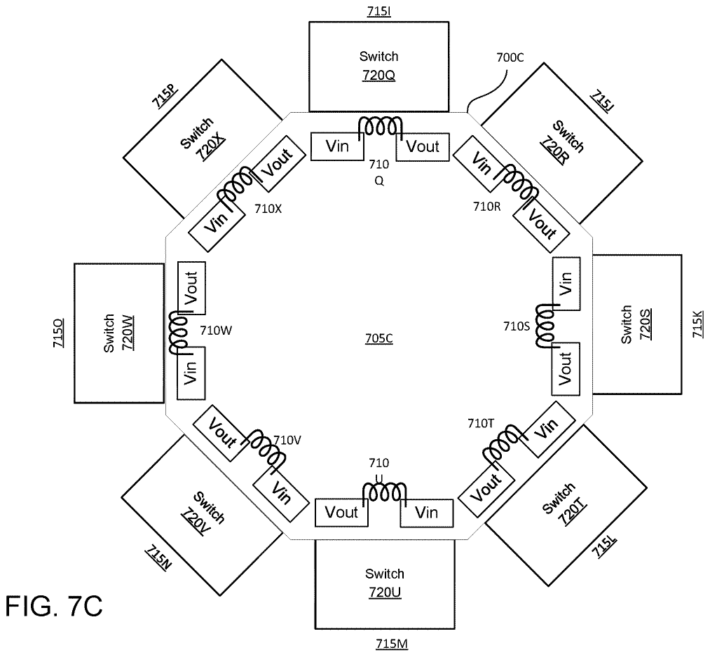

Many of the integrated inductor packages described herein with respect to FIGS. 1-6 include four conductive coils. However, as described herein, integrated inductor packages can include more or fewer than four conductive coils. In some examples, an integrated inductor package includes two conductive coils or three conductive coils. In some examples, an integrated inductor package includes six conductive coils, eight conductive coils, ten conductive coils, twelve conductive coils, or some other number of conductive coils. FIGS. 7A-7C illustrate top-down views of different exemplar integrated inductor packages, according to various other embodiments.

FIG. 7A illustrates a top-down view of an integrated inductor package 700A that includes a magnetic core 705A that is coupled to eight conductive coils 710A-710H. Similar to the magnetic core 105 described with respect to FIGS. 1A-1E, the magnetic core 705A can be formed of one or suitable more alloy powder materials. The magnetic core 705A has a rectangular shape such that the integrated inductor package 700A has a first side 715A, a second side 715B, a third side 715C, and a fourth side 715D. As shown in the illustrated example of FIG. 7A, the first conductive coil 710A, the second conductive coil 710B, the third conductive coil 710C, and the fourth conductive coil 710D are disposed on the first side 715A of the integrated inductor package 700A. In this regard, four phase switches 720A-720D can be arranged adjacent to the first side 715A of the integrated inductor package 700A and respectively coupled to the conductive coils 710A-710D disposed on the first side 715A of the integrated inductor package 700A. As further shown in the illustrated example of FIG. 7A, the fifth conductive coil 710E, the sixth conductive coil 710F, the seventh conductive coil 710G, and the eighth conductive coil 710H are disposed on the second side 715B of the integrated inductor package 700A. In this regard, four phase switches 720E-720H can be arranged adjacent to the second side 715B of the integrated inductor package 700A and respectively coupled to the conductive coils 710E-710H disposed on the second side 715B of the integrated inductor package 700A.

FIG. 7B illustrates a top-down view of an integrated inductor package 700B that includes a magnetic core 705B that is coupled to eight conductive coils 710I-710P. Similar to the magnetic core 105 described with respect to FIGS. 1A-1E, the magnetic core 705B can be formed of one or suitable more alloy powder materials. The magnetic core 705B has a rectangular shape such that the integrated inductor package 700B has a first side 715E, a second side 715F, a third side 715G, and a fourth side 715H. As shown in the illustrated example of FIG. 7B, the first conductive coil 710I and the second conductive coil 710J are disposed on the first side 715E of the integrated inductor package 700B. In this regard, two phase switches 720I and 720J can be arranged adjacent to the first side 715E of the integrated inductor package 700B and respectively coupled to the first and second conductive coils 710I, 710J disposed on the first side 715E of the integrated inductor package 700B. As further shown in the illustrated example of FIG. 7B, the third conductive coil 710K and the fourth conductive coil 710L are disposed on the second side 715F of the integrated inductor package 700B. In this regard, two phase switches 720K and 720LD can be arranged adjacent to the second side 715F of the integrated inductor package 700B and respectively coupled to the third and fourth conductive coils 710K, 710L disposed on the second side 715F of the integrated inductor package 700B. In addition, the fifth conductive coil 710M and the sixth conductive coil 710N are disposed on the third side 715G of the integrated inductor package 700B. In this regard, two phase switches 720M and 720N can be arranged adjacent to the third side 715G of the integrated inductor package 700B and respectively coupled to the fifth and sixth conductive coils 710M, 710N disposed on the third side 715G of the integrated inductor package 700B. Furthermore, the seventh conductive coil 710O and the eighth conductive coil 710P are disposed on the fourth side 715H of the integrated inductor package 700B. In this regard, two phase switches 720O and 720P can be arranged adjacent to the fourth side 715H of the integrated inductor package 700B and respectively coupled to the seventh and eighth conductive coils 710O, 710P disposed on the fourth side 715H of the integrated inductor package 700B.

FIG. 7C illustrates a top-down view of an integrated inductor package 700C that includes a magnetic core 705C that is coupled to eight conductive coils 710Q-710X. Similar to the magnetic core 105 described with respect to FIGS. 1A-1E, the magnetic core 705C can be formed of one or suitable more alloy powder materials. The magnetic core 705C has an octagonal shape such that the integrated inductor package 700C has a first side 715I, a second side 715J, a third side 715K, a fourth side 715L, a fifth side 715M, a sixth side 715N, a seventh side 715O, and an eighth side 715P. As shown in the illustrated example of FIG. 7C, the first conductive coil 710Q is disposed on the first side 715I of the integrated inductor package 700C, the second conductive coil 710R is disposed on the second side 715J of the integrated inductor package 700C, the third conductive coil 710S is disposed on the third side 715K of the integrated inductor package 700C, the fourth conductive coil 710T is disposed on the fourth side 715L of the integrated inductor package 700C, the fifth conductive coil 710U is disposed on the fifth side 715M of the integrated inductor package 700C, the sixth conductive coil 710V is disposed on the sixth side 715N of the integrated inductor package 700C, the seventh conductive coil 710W is disposed on the seventh side 715O of the integrated inductor package 700C, and the eighth conductive coil 710X is disposed on the eighth side 715P of the integrated inductor package 700C. In this regard, a first phase switch 720Q can be arranged adjacent to the first side 715I of the integrated inductor package 700C and coupled to the first conductive coil 710Q, a second phase switch 720R can be arranged adjacent to the second side 715J of the integrated inductor package 700C and coupled to the second conductive coil 710R, a third phase switch 720S can be arranged adjacent to the third side 715K of the integrated inductor package 700C and coupled to the third conductive coil 710S, a fourth phase switch 720T can be arranged adjacent to the fourth side 715L of the integrated inductor package 700C and coupled to the fourth conductive coil 710T, a fifth phase switch 720U can be arranged adjacent to the fifth side 715M of the integrated inductor package 700C and coupled to the fifth conductive coil 710U, a sixth phase switch 720V can be arranged adjacent to the sixth side 715N of the integrated inductor package 700C and coupled to the first conductive coil 710V, a seventh phase switch 720W can be arranged adjacent to the seventh side 715O of the integrated inductor package 700C and coupled to the seventh conductive coil 710W, and an eighth phase switch 720XH can be arranged adjacent to the eighth side 715P of the integrated inductor package 700C and coupled to the eighth conductive coil 710X.

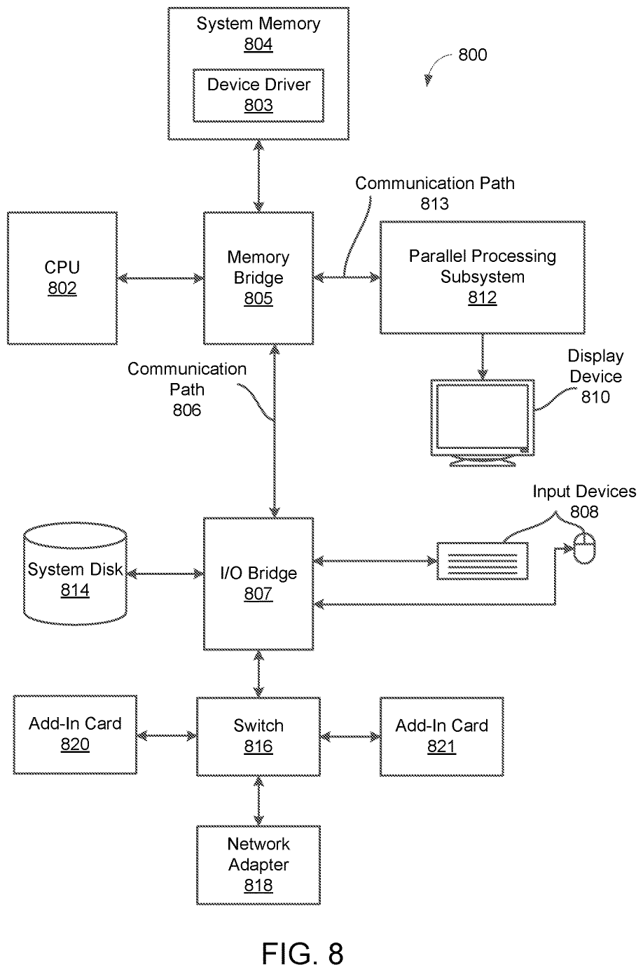

FIG. 8 is a block diagram illustrating a computer system 800 configured to implement one or more aspects of various embodiments. In some embodiments, computer system 800 is a machine or processing node operating in a data center, cluster, or cloud computing environment that provides scalable computing resources (optionally as a service) over a network. In some embodiments, the computer system 800 is a high-performance computing system or device such as, without limitation, a server machine, a server platform, a desktop machine, a laptop machine, a hand-held/mobile device, or a wearable device. As will be described in more detail below, the computer system 800 includes one or more electronic components that can be powered by multiphase power supplies that implement one or more of the integrated inductor packages described herein with respect to FIGS. 1-7C. Stated another way, the computer system 800 includes and/or is coupled to one or more multiphase power supplies that include one or more integrated inductor packages described herein, wherein the one or more multiphase power supplies provide power to one or more of the electronic components of the computer system 800.

In various embodiments, computer system 800 includes, without limitation, a central processing unit (CPU) 802 and a system memory 804 coupled to a parallel processing subsystem 812 via a memory bridge 805 and a communication path 813. Memory bridge 805 is further coupled to an I/O (input/output) bridge 807 via a communication path 806, and I/O bridge 807 is, in turn, coupled to a switch 816. In operation of the computer system 800, one or more of the CPU 802, the system memory 804, and/or the parallel processing subsystem 812 can be coupled to and powered by a multiphase power supply, such as the multiphase power supply 600, that implements one or more of the integrated inductor packages described herein with respect to FIG. 1-7C.

In one embodiment, I/O bridge 807 is configured to receive user input information from optional input devices 808, such as a keyboard or a mouse, and forward the input information to CPU 802 for processing via communication path 806 and memory bridge 805. In some embodiments, computer system 800 may be a server machine in a cloud computing environment. In such embodiments, computer system 800 may not have input devices 808. Instead, computer system 800 may receive equivalent input information by receiving commands in the form of messages transmitted over a network and received via the network adapter 818. In one embodiment, switch 816 is configured to provide connections between I/O bridge 807 and other components of the computer system 800, such as a network adapter 818 and various add-in cards 820 and 821.

In one embodiment, I/O bridge 807 is coupled to a system disk 814 that may be configured to store content and applications and data for use by CPU 802 and parallel processing subsystem 812. In one embodiment, system disk 814 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high definition DVD), or other magnetic, optical, or solid state storage devices. In various embodiments, other components, such as universal serial bus or other port connections, compact disc drives, digital versatile disc drives, film recording devices, and the like, may be coupled to I/O bridge 807 as well.

In various embodiments, memory bridge 805 may be a Northbridge chip, and I/O bridge 807 may be a Southbridge chip. In addition, communication paths 806 and 813, as well as other communication paths within computer system 800, may be implemented using any technically suitable protocols, including, without limitation, AGP (Accelerated Graphics Port), HyperTransport, or any other bus or point-to-point communication protocol known in the art.

In some embodiments, parallel processing subsystem 812 includes a graphics subsystem that delivers pixels to an optional display device 810 that may be any conventional cathode ray tube, liquid crystal display, light-emitting diode display, or the like. In such embodiments, the parallel processing subsystem 812 incorporates circuitry optimized for graphics and video processing, including, for example, video output circuitry. Such circuitry may be incorporated across one or more parallel processing units (PPUs), also referred to herein as parallel processors, included within parallel processing subsystem 812. In other embodiments, the parallel processing subsystem 812 incorporates circuitry optimized for general purpose and/or compute processing. Again, such circuitry may be incorporated across one or more PPUs included within parallel processing subsystem 812 that are configured to perform such general purpose and/or compute operations. In yet other embodiments, the one or more PPUs included within parallel processing subsystem 812 may be configured to perform graphics processing, general purpose processing, and compute processing operations. System memory 804 includes at least one device driver 803 configured to manage the processing operations of the one or more PPUs within parallel processing subsystem 812. In some embodiments, the one or more PPUs can be powered by one or more multiphase power supplies, such as the multiphase power supply 600, that implements one or more of the integrated inductor packages described herein with respect to FIGS. 1-7C.

In various embodiments, parallel processing subsystem 812 may be integrated with one or more of the other elements of FIG. 8 to form a single system. For example, parallel processing subsystem 812 may be integrated with CPU 802 and other connection circuitry on a single chip to form a system on chip (SoC).

In one embodiment, CPU 802 is the master processor of computer system 800, controlling and coordinating operations of other system components. In one embodiment, CPU 802 issues commands that control the operation of PPUs. In some embodiments, communication path 813 is a PCI Express link, in which dedicated lanes are allocated to each PPU, as is known in the art. Other communication paths may also be used. PPU advantageously implements a highly parallel processing architecture. A PPU may be provided with any amount of local parallel processing memory (PP memory).

It will be appreciated that the system shown herein is illustrative and that variations and modifications are possible. The connection topology, including the number and arrangement of bridges, the number of CPUs 802, and the number of parallel processing subsystems 812, may be modified as desired. For example, in some embodiments, system memory 804 could be coupled to CPU 802 directly rather than through memory bridge 805, and other devices would communicate with system memory 804 via memory bridge 805 and CPU 802. In other embodiments, parallel processing subsystem 812 may be coupled to I/O bridge 807 or directly to CPU 802, rather than to memory bridge 805. In still other embodiments, I/O bridge 807 and memory bridge 805 may be integrated into a single chip instead of existing as one or more discrete devices. Lastly, in certain embodiments, one or more components shown in FIG. 8 may not be present. For example, switch 816 could be eliminated, and network adapter 818 and add-in cards 820, 821 would connect directly to I/O bridge 807.

In sum, an integrated inductor package includes a magnetic core and a plurality of conductive coils coupled to the magnetic core. Each conductive coil in the plurality of conductive coils is coupled between a respective input pin and a respective output pin. A first conductive coil in the plurality of conductive coils can be disposed on a first side of the integrated inductor package that is different than a second side of the integrated inductor package on which a second conductive coil in the plurality of conductive coils is disposed. The integrated inductor package can be implemented in a multiphase power supply that provides power to a load. In this regard, each conductive coil included in the integrated inductor package couples a respective phase switch to the load. In operation, when a respective phase switch is turned ON, the phase switch outputs current that flows through a conductive coil included in the integrated inductor package to the load.

At least one technical advantage of the disclosed multiphase power supply design relative to the prior art is that, in the disclosed design, the amount of space occupied by the inductors is reduced relative to conventional approaches. In this regard, in the disclosed design, multiple inductor coils are included in an integrated inductor package that occupies less physical space on a printed circuit board than an equivalent number of the discrete inductor packages used in conventional multiphase power supply designs. Further, by reducing the amount of space occupied on a printed circuit board by the inductors in the disclosed design, the phase switches can be positioned closer on the printed circuit board closer to the load to which the phase switches deliver power, which reduces the amount of copper losses in the multiphase power supply. At least another technical advantage of the disclosed design is that inductor coils included in the integrated inductor package are magnetically coupled to one another. In this regard, the respective inductances of the inductor coils in the disclosed integrated inductor package are maintained during steady-state operation of the multiphase power supply and reduced during transient operation of the multiphase power supply, which improves the overall transient performance of the multiphase power supply. In addition, the coupled inductor coils can be arranged within the disclosed integrated inductor package such that the magnetic fields generated by the different inductor coils within the package oppose one another, which reduces the overall level of electromagnetic interference during operation relative to the levels that typically result in prior art inductor package designs. These technical advantages represent one or more technological improvements over prior art approaches.

1. In some embodiments, an integrated inductor package comprises: a magnetic core; a first conductive coil coupled to the magnetic core and disposed on a first side of the integrated inductor package, the first conductive coil coupled between a first input pin and a first output pin; and a second conductive coil coupled to the magnetic core, magnetically coupled to the first conductive coil, and disposed on a second side of the integrated inductor package, the second conductive coil coupled between a second input pin and a second output pin.

2. The integrated inductor package according to clause 1, wherein the first side of the integrated inductor package is opposite the second side of the integrated inductor package.

3. The integrated inductor package according to clause 1 or clause 2, further comprising: a third conductive coil coupled to the magnetic core and disposed on the first side of the integrated inductor package, the third conductive coil coupled between a third input pin and a third output pin; and a fourth conductive coil coupled to the magnetic core and disposed on the second side of the integrated inductor package, the fourth conductive coil coupled between a fourth input pin and a fourth output pin.

4. The integrated inductor package according to any of clauses 1-3, further comprising: a fifth conductive coil coupled to the magnetic core and disposed on a third side of the integrated inductor package, the fifth conductive coil coupled between a fifth input pin and a fifth output pin; a sixth conductive coil coupled to the magnetic core and disposed on the third side of the integrated inductor package, the sixth conductive coil comprising a sixth coil coupled between a sixth input pin and a sixth output pin; a seventh conductive coil coupled to the magnetic core and disposed on a fourth side of the integrated inductor package, the seventh conductive coil coupled between a seventh input pin and a seventh output pin; and an eighth inductor coupled to the magnetic core and disposed on the fourth side of the integrated inductor package, the eighth inductor comprising an eighth coil coupled between an eighth input pin and an eighth output pin.

5. The integrated inductor package according to any of clauses 1-4, further comprising: a third conductive coil coupled to the magnetic core, the third conductive coil coupled between a third input pin and a third output pin; and a fourth conductive coil coupled to the magnetic core, the fourth conductive coil coupled between a fourth input pin and a fourth output pin.

6. The integrated inductor package according to any of clauses 1-5, wherein the third conductive coil is disposed on a third side of the integrated inductor package and the fourth conductive coil is disposed on a fourth side of the integrated inductor package.

7. The integrated inductor package according to any of clauses 1-6, wherein a first footprint of the first conductive coil and a second footprint of the second conductive coil are not overlapping.

8. The integrated inductor package according to any of clauses 1-7, wherein a first footprint of the first conductive coil overlaps with a second footprint of the second conductive coil.

9. The integrated inductor package according to any of clauses 1-8, wherein a first footprint of the first conductive coil intertwines with a second footprint of the second conductive coil.

10. The integrated inductor package according to any of clauses 1-9, wherein at least one of the first conductive coil or the second conductive coil comprises a rounded shape, a straight shape, a rectangular shape, a bent shape, a curved shape, or a helical shape.

11. In some embodiments, a multiphase power supply comprises: an integrated inductor package that includes: a magnetic core; a first conductive coil coupled to the magnetic core and disposed on a first side of the integrated inductor package, the first conductive coil coupled between a first input pin and a first output pin; and a second conductive coil coupled to the magnetic core, magnetically coupled to the first conductive coil, and disposed on a second side of the integrated inductor package, the second conductive coil coupled between a second input pin and a second output pin; a first switch disposed adjacent to the first side of the integrated inductor package and coupled to the first input pin; and a second switch disposed adjacent to the second side of the integrated inductor package and coupled to the second input pin.

12. The multiphase power supply according to clause 11, wherein the integrated inductor package further comprises: a third conductive coil coupled to the magnetic core and disposed on the first side of the integrated inductor package, the third conductive coil coupled between a third input pin and a third output pin; a fourth conductive coil coupled to the magnetic core and disposed on the second side of the integrated inductor package, the fourth conductive coil coupled between a fourth input pin and a fourth output pin; a third switch disposed adjacent to the first side of the integrated inductor package and coupled to the third input pin; and a fourth switch disposed adjacent to the second side of the integrated inductor package and coupled to the fourth input pin.

13. The multiphase power supply according to clause 11 or clause 12, wherein the integrated inductor package further comprises: a third conductive coil coupled to the magnetic core and disposed on a third side of the integrated inductor package, the third conductive coil coupled between a third input pin and a third output pin; a fourth conductive coil coupled to the magnetic core and disposed on a fourth side of the integrated inductor package, the fourth conductive coil coupled between a fourth input pin and a fourth output pin; a third switch disposed adjacent to the third side of the integrated inductor package and coupled to the third input pin; and a fourth switch disposed adjacent to the fourth side of the integrated inductor package and coupled to the fourth input pin.

14. The multiphase power supply according to any of clauses 11-13, wherein current output by the first switch flows in a first direction relative to the integrated inductor package through the first conductive coil; and wherein current output by the second switch flows in a second direction relative to the integrated inductor package through the second conductive coil, the second direction opposite to the first direction.

15. The multiphase power supply according to any of clauses 11-14, wherein current output by the first switch flows in a first direction relative to the integrated inductor package through the first conductive coil; and wherein current output by the second switch flows in the first direction relative to the integrated inductor package through the second conductive coil.

16. The multiphase power supply according to any of clauses 11-15, wherein a first footprint of the first conductive coil and a second footprint of the second conductive coil are not overlapping.

17. The multiphase power supply according to any of clauses 11-16, wherein a first footprint of the first conductive coil overlaps with a second footprint of the second conductive coil.

18. The multiphase power supply according to any of clauses 11-17, wherein a first footprint of the first conductive coil intertwines with a second footprint of the second conductive coil.

19. The multiphase power supply according to any of clauses 11-18, wherein at least one of the first conductive coil or the second conductive coil comprises a rounded shape, a straight shape, a rectangular shape, a bent shape, a curved shape, or a helical shape.

20. In some embodiments, a system comprises: an integrated inductor package that includes: a magnetic core; a first conductive coil coupled to the magnetic core and disposed on a first side of the integrated inductor package, the first conductive coil coupled between a first input pin and a first output pin; and a second conductive coil coupled to the magnetic core, magnetically coupled to the first conductive coil, and disposed on a second side of the integrated inductor package, the second conductive coil coupled between a second input pin and a second output pin; a first switch disposed adjacent to the first side of the integrated inductor package and coupled to the first input pin; a second switch disposed adjacent to the second side of the integrated inductor package and coupled to the second input pin; and an electronic component coupled to at least one of the first output pin or the second output pin.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

While the preceding is directed to embodiments of the present disclosure, other and further embodiments of the disclosure may be devised without departing from the basic scope thereof, and the scope thereof is determined by the claims that follow.

What is claimed is:

1. An integrated inductor package, comprising:
a magnetic core;
a first conductive coil coupled to the magnetic core and disposed on a first side of the integrated inductor package, the first conductive coil coupled between a first input pin and a first output pin; and
a second conductive coil coupled to the magnetic core, magnetically coupled to the first conductive coil, and disposed on a second side of the integrated inductor package, the second conductive coil coupled between a second input pin and a second output pin.

2. The integrated inductor package of claim 1, wherein the first side of the integrated inductor package is opposite the second side of the integrated inductor package.

3. The integrated inductor package of claim 1, further comprising:
a third conductive coil coupled to the magnetic core and disposed on the first side of the integrated inductor package, the third conductive coil coupled between a third input pin and a third output pin; and
a fourth conductive coil coupled to the magnetic core and disposed on the second side of the integrated inductor package, the fourth conductive coil coupled between a fourth input pin and a fourth output pin.

4. The integrated inductor package of claim 3, further comprising:
a fifth conductive coil coupled to the magnetic core and disposed on a third side of the integrated inductor package, the fifth conductive coil coupled between a fifth input pin and a fifth output pin;
a sixth conductive coil coupled to the magnetic core and disposed on the third side of the integrated inductor package, the sixth conductive coil comprising a sixth coil coupled between a sixth input pin and a sixth output pin;
a seventh conductive coil coupled to the magnetic core and disposed on a fourth side of the integrated inductor package, the seventh conductive coil coupled between a seventh input pin and a seventh output pin; and
an eighth inductor coupled to the magnetic core and disposed on the fourth side of the integrated inductor package, the eighth inductor comprising an eighth coil coupled between an eighth input pin and an eighth output pin.

5. The integrated inductor package of claim 1, further comprising:
a third conductive coil coupled to the magnetic core, the third conductive coil coupled between a third input pin and a third output pin; and
a fourth conductive coil coupled to the magnetic core, the fourth conductive coil coupled between a fourth input pin and a fourth output pin.

6. The integrated inductor package of claim 5, wherein the third conductive coil is disposed on a third side of the integrated inductor package and the fourth conductive coil is disposed on a fourth side of the integrated inductor package.

7. The integrated inductor package of claim 1, wherein a first footprint of the first conductive coil and a second footprint of the second conductive coil are not overlapping.

8. The integrated inductor package of claim 1, wherein a first footprint of the first conductive coil overlaps with a second footprint of the second conductive coil.

9. The integrated inductor package of claim 1, wherein a first footprint of the first conductive coil intertwines with a second footprint of the second conductive coil.

10. The integrated inductor package of claim 1, wherein at least one of the first conductive coil or the second conductive coil comprises a rounded shape, a straight shape, a rectangular shape, a bent shape, a curved shape, or a helical shape.

11. A multiphase power supply, comprising:
an integrated inductor package that includes:
a magnetic core;
a first conductive coil coupled to the magnetic core and disposed on a first side of the integrated inductor package, the first conductive coil coupled between a first input pin and a first output pin; and
a second conductive coil coupled to the magnetic core, magnetically coupled to the first conductive coil, and disposed on a second side of the integrated inductor package, the second conductive coil coupled between a second input pin and a second output pin;
a first switch disposed adjacent to the first side of the integrated inductor package and coupled to the first input pin; and
a second switch disposed adjacent to the second side of the integrated inductor package and coupled to the second input pin.

12. The multiphase power supply of claim 11, wherein the integrated inductor package further comprises:
a third conductive coil coupled to the magnetic core and disposed on the first side of the integrated inductor package, the third conductive coil coupled between a third input pin and a third output pin;
a fourth conductive coil coupled to the magnetic core and disposed on the second side of the integrated inductor package, the fourth conductive coil coupled between a fourth input pin and a fourth output pin;
a third switch disposed adjacent to the first side of the integrated inductor package and coupled to the third input pin; and
a fourth switch disposed adjacent to the second side of the integrated inductor package and coupled to the fourth input pin.

13. The multiphase power supply of claim 11, wherein the integrated inductor package further comprises:
a third conductive coil coupled to the magnetic core and disposed on a third side of the integrated inductor package, the third conductive coil coupled between a third input pin and a third output pin;
a fourth conductive coil coupled to the magnetic core and disposed on a fourth side of the integrated inductor package, the fourth conductive coil coupled between a fourth input pin and a fourth output pin;
a third switch disposed adjacent to the third side of the integrated inductor package and coupled to the third input pin; and
a fourth switch disposed adjacent to the fourth side of the integrated inductor package and coupled to the fourth input pin.

14. The multiphase power supply of claim 11, wherein current output by the first switch flows in a first direction relative to the integrated inductor package through the first conductive coil; and
wherein current output by the second switch flows in a second direction relative to the integrated inductor package through the second conductive coil, the second direction opposite to the first direction.

15. The multiphase power supply of claim 11, wherein current output by the first switch flows in a first direction relative to the integrated inductor package through the first conductive coil; and
wherein current output by the second switch flows in the first direction relative to the integrated inductor package through the second conductive coil.

16. The multiphase power supply of claim 11, wherein a first footprint of the first conductive coil and a second footprint of the second conductive coil are not overlapping.

17. The multiphase power supply of claim 11, wherein a first footprint of the first conductive coil overlaps with a second footprint of the second conductive coil.

18. The multiphase power supply of claim 11, wherein a first footprint of the first conductive coil intertwines with a second footprint of the second conductive coil.

19. The multiphase power supply of claim 11, wherein at least one of the first conductive coil or the second conductive coil comprises a rounded shape, a straight shape, a rectangular shape, a bent shape, a curved shape, or a helical shape.

20. A system comprising:
an integrated inductor package that includes:
a magnetic core;
a first conductive coil coupled to the magnetic core and disposed on a first side of the integrated inductor package, the first conductive coil coupled between a first input pin and a first output pin; and
a second conductive coil coupled to the magnetic core, magnetically coupled to the first conductive coil, and disposed on a second side of the integrated inductor package, the second conductive coil coupled between a second input pin and a second output pin;
a first switch disposed adjacent to the first side of the integrated inductor package and coupled to the first input pin;
a second switch disposed adjacent to the second side of the integrated inductor package and coupled to the second input pin; and
an electronic component coupled to at least one of the first output pin or the second output pin.
